(19) United States
(12) Patent Application Publication
(10) Pub. No.: US 2026/0208716 A1
(43) Pub. Date: Jul. 23, 2026

(54) BRAKE APPARATUS FOR VEHICLE

(71) Applicant: HYUNDAI MOBIS CO., LTD., Seoul (KR)

(72) Inventors: Sang Pil BOO, Yongin-si (KR); Sang Jun PARK, Yongin-si (KR); Kang Kuk LEE, Yongin-si (KR); Choong Sik SHIN, Yongin-si (KR); Se Hoon AN, Yongin-si (KR)

(73) Assignee: HYUNDAI MOBIS CO., LTD., Seoul (KR)

(21) Appl. No.: 19/386,885

(22) Filed: Nov. 12, 2025

(30) Foreign Application Priority Data
Jan. 22, 2025 (KR) 10-2025-0009678
Mar. 19, 2025 (KR) 10-2025-0035584

(51) Int. Cl. B60T 13/74; F16D 55/226; F16D 65/00; F16D 65/18; F16D 121/24; F16D 125/40

(52) U.S. Cl. CPC B60T 13/746; F16D 55/226; F16D 65/005; F16D 65/18; F16D 65/183; F16D 2121/24; F16D 2125/40

(57) ABSTRACT

A brake apparatus for a vehicle includes a cylinder, a nut screw rotatably disposed in the cylinder, a bolt screw being movable in a first direction or a direction opposite to the first direction while operating in conjunction with the rotation of the nut screw, a piston movably disposed in the cylinder and moved in the first direction by the pressurization of the bolt screw, a caliper body surrounding a part of the cylinder, and a fastening member fastening the cylinder to the caliper body.

### CROSS-REFERENCE TO RELATED APPLICATIONS

This application claims priority from and the benefit of Korean Patent Application Nos. 10-2025-0009678 and 10-2025-0035584, filed on January 22 and March 19, 2025, respectively, which are hereby incorporated by reference for all purposes as if set forth herein.

### BACKGROUND

### Field

Exemplary embodiments of the present disclosure relate to a brake apparatus for a vehicle, and more particularly, to a brake apparatus for a vehicle, which can secure stable braking performance.

### Description of the Related Art

In general, the brake apparatus for a vehicle closely attaches a pad and a disk by pushing a piston by its driving force and brakes the vehicle by using a frictional force between the pad and the disk.

An electro mechanical brake (EMB), among brake apparatuses for a vehicle, has a motor driving actuator mounted on a caliper without using hydraulic pressure, and generates a braking force by pressurizing a piston through a mechanism in which the rotational motion of a screw is converted into the linear motion of a nut or the rotational motion of the nut is converted into the linear motion of the screw.

The EMB can implement each of additional functions, such as an anti-lock brake system (ABS), electric stability control (ESC), a traction control system (TCS), and automatic emergency braking (AEB), in addition to common main braking because the EMB enables active braking and wheel-based independent braking, and can implement higher performance because there is no delay in the transmission of hydraulic pressure.

A conventional EMB has a structure in which a processing shape of a caliper body is complicated and the number of assembly parts is many. Accordingly, there are problems in that the time and costs required for processing and assembly processes are increased and initial investment costs also rise. Furthermore, it is difficult to apply the existing EMB to a high-load environment or an apparatus having a multi-piston structure including two or more pistons. Accordingly, the enlargement of a braking force or the handling of various vehicle environments is restricted. Due to such a structural limit, there is also a limit in terms of durability and stability.

The background technology of the present disclosure is disclosed in Korean Patent Application Publication No. 10-2024-0054695 (April 26, 2024) entitled “BRAKE APPARATUS FOR VEHICLE”).

### SUMMARY

Various embodiments are directed to providing a brake apparatus for a vehicle, which can improve braking performance by securing the stiffness of a caliper.

In an embodiment, a brake apparatus for a vehicle includes a cylinder, a nut screw rotatably disposed in the cylinder, a bolt screw being movable in a first direction or a direction opposite to the first direction while operating in conjunction with the rotation of the nut screw, a piston movably disposed in the cylinder and moved in the first direction by the pressurization of the bolt screw, a caliper body surrounding a part of the cylinder, and a fastening member fastening the cylinder to the caliper body.

A direction in which the fastening member is fastened may be directed toward a direction parallel to a second direction that intersects the first direction.

The cylinder may include a cylinder body part and a flange part protruding a third direction that intersects the first direction and the second direction from an outer circumferential surface of the cylinder body part and including a through-hole through which a part of the fastening member passes.

A plurality of flange parts may be disposed to be spaced apart from each other in the circumferential direction of the cylinder body part.

The caliper body may include a tapped portion that comes into contact with the flange part and in which a tapped hole with which the fastening member that passes through the through-hole is combined is formed.

The fastening member may include a first fastening member and a second fastening member disposed to be spaced apart from the first fastening member in the direction opposite to the first direction.

The diameter of the first fastening member and the diameter of the second fastening member may be different.

The diameter of the first fastening member may be greater than the diameter of the second fastening member.

The flange part may include a first flange part through which the first fastening member passes and a second flange part that extends in the direction opposite to the first direction from the first flange part and through which the second fastening member passes.

The height of the first flange part and the height of the second flange part that are parallel to the second direction may be different.

The height of the second flange part may be lower than the height of the first flange part.

The tapped portion may include a first tapped portion configured to come into contact with the first flange part and a second tapped portion extending in the direction opposite to the first direction from the first tapped portion and configured to come into contact with the second flange part.

The height of the first tapped portion and the height of the second tapped portion that are parallel to the second direction may be different.

The height of the first tapped portion may be lower than the height of the second tapped portion.

In an embodiment, a brake apparatus for a vehicle includes a cylinder part including a first cylinder and a second cylinder, a caliper body surrounding a part of the cylinder part, and a fastening member fastening the cylinder part to the caliper body.

The brake apparatus may further include a first nut screw rotatably disposed in the first cylinder, a first bolt screw being movable in a first direction or a direction opposite to the first direction while operating in conjunction with the rotation of the first nut screw, and a first piston movably disposed in the first cylinder and moved in the first direction by the pressurization of the first bolt screw.

The brake apparatus may further include a second nut screw rotatably disposed in the second cylinder, a second bolt screw being movable in the first direction or the direction opposite to the first direction while operating in conjunction with the rotation of the second nut screw, and a second piston movably disposed in the second cylinder and moved in the first direction by the pressurization of the second bolt screw.

A direction in which the fastening member is fastened may be directed toward a direction parallel to a second direction that intersects the first direction.

The fastening member may include a first fastening member and a second fastening member disposed to be spaced apart from the first fastening member in a direction parallel to the first direction.

The diameter of the first fastening member and the diameter of the second fastening member may be different.

The cylinder part may include a cylinder body and a flange part that protrudes from the outer circumferential surface of the cylinder body and that includes a through-hole through which a part of the fastening member passes.

The flange part may include a first flange part and a second flange part disposed to be spaced apart from the first flange part in a direction parallel to the third direction that intersects the first direction and the second direction.

The cylinder part may further include a tapped portion that is provided in the cylinder body and disposed between the first flange part and the second flange part and with which the fastening member is combined.

The fastening member may further include a third fastening member combined with the tapped portion through the caliper body.

Embodiments of the present disclosure have an effect in that the stiffness of the caliper body can be secured by minimizing a load that is applied to the fastening member because a shearing load is supported when the braking force of the caliper body is generated by the plurality of fastening members that fasten the cylinder and the caliper body.

Embodiments of the present disclosure have effects, such as a reduction in the size of the cylinder, quality stabilization through the publicization of all KIT specifications, a reduction of investment costs, and the enhancement of competitiveness attributable to the maximization of output because the cylinder including the ball screw and the piston can be composed of a compact modularization KIT and assembled with the caliper body.

Embodiments of the present disclosure have an effect in that the length of the brake apparatus for a vehicle in the axial direction thereof can be minimized by applying the nut-driven type in which a rotational motion of the nut is changed into a linear motion of the screw.

Embodiments of the present disclosure have an effect in that the weight of the brake apparatus for a vehicle can be reduced through material dualization and a reduction of the size.

Embodiments of the present disclosure have an effect in that profitability can be improved because productivity and production efficiency can be increased by process and assembly improvements.

### BRIEF DESCRIPTION OF THE DRAWINGS

FIGS. 1 and 2 are perspective views of a brake apparatus for a vehicle, which are viewed from an upper side, according to a first embodiment of the present disclosure.

FIG. 3 is a diagram of the brake apparatus for a vehicle, which is viewed from a lower side, according to the first embodiment of the present disclosure.

FIG. 4 is an exploded perspective view illustrating the brake apparatus for a vehicle according to the first embodiment of the present disclosure.

FIG. 5 is a cross-sectional view taken along line V-V in FIG. 4.

FIG. 6 is a partially enlarged view of FIG. 5.

FIG. 7 is an exploded perspective view of the brake apparatus for a vehicle, which is viewed from an upper side, according to the first embodiment of the present disclosure.

FIG. 8 is an exploded perspective view of the brake apparatus for a vehicle, which is viewed from a lower side, according to the first embodiment of the present disclosure.

FIG. 9 is a perspective view illustrating a cylinder according to the first embodiment of the present disclosure.

FIG. 10 is an exploded perspective view of a brake apparatus for a vehicle, which is viewed from an upper side, according to a second embodiment of the present disclosure.

FIG. 11 is an exploded perspective view of the brake apparatus for a vehicle, which is viewed from an upper side, according to the second embodiment of the present disclosure.

FIG. 12 is a perspective view illustrating a cylinder according to the second embodiment of the present disclosure.

FIGS. 13 and 14 are perspective views of the brake apparatus for a vehicle according to a third embodiment of the present disclosure, which are viewed from an upper side.

FIG. 15 is a perspective view of the brake apparatus for a vehicle, which is viewed from a lower side, according to a third embodiment of the present disclosure.

FIG. 16 is an exploded perspective view of the brake apparatus for a vehicle, which is viewed from an upper side, according to the third embodiment of the present disclosure.

FIG. 17 is an exploded perspective view of the brake apparatus for a vehicle, which is viewed from a lower side, according to the third embodiment of the present disclosure.

FIG. 18 is a perspective view illustrating a cylinder part according to the third embodiment of the present disclosure.

FIG. 19 is a cross-sectional view taken along line VII-VII in FIG. 13.

FIG. 20 is an enlarged view of VIII in FIG. 19.

FIG. 21 is a cross-sectional view taken along line IX-IX in FIG. 13.

FIG. 22 is an enlarged view of X in FIG. 21.

### DETAILED DESCRIPTION

Hereinafter, brake apparatuses for a vehicle according to embodiments of the present disclosure are described with reference to the accompanying drawings. In this process, the thicknesses of lines or the sizes of components illustrated in the drawings may have been exaggerated for the clarity of a description and for convenience’ sake. Terms to be described below have been defined by taking into consideration their functions in the present disclosure, and may be changed depending on a user or operator’s intention or practice. Accordingly, such terms should be defined based on the overall contents of this specification.

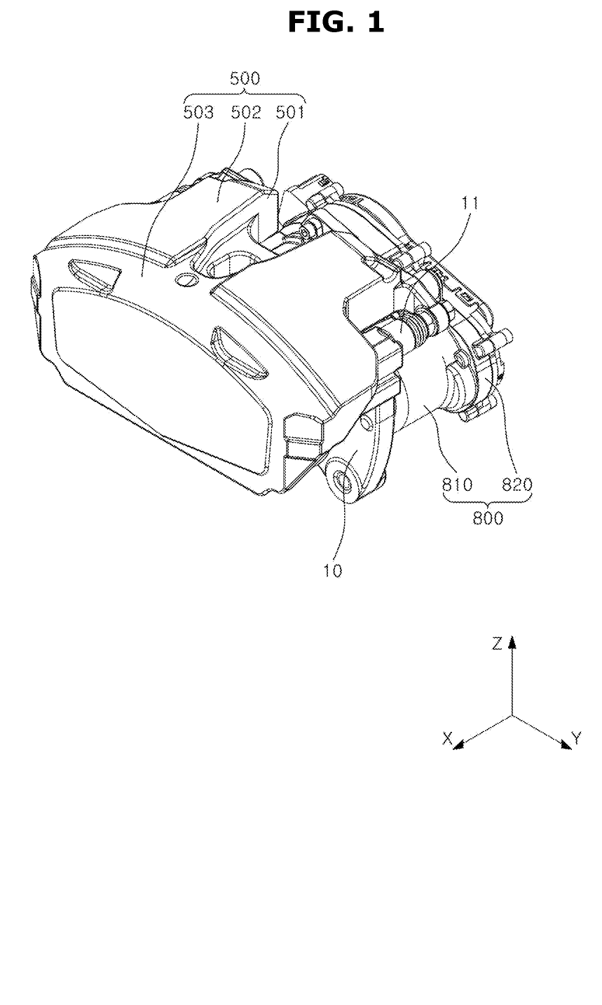

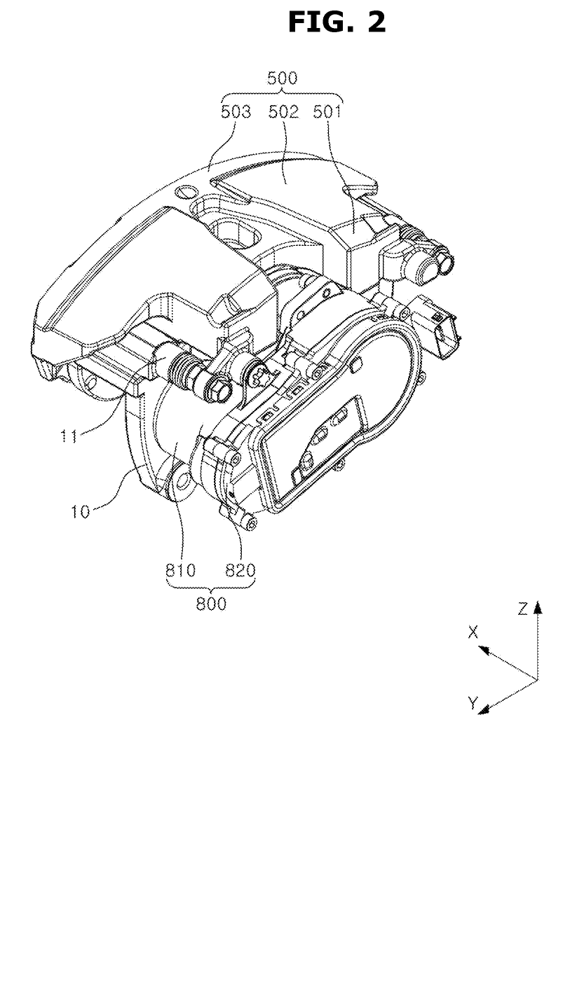

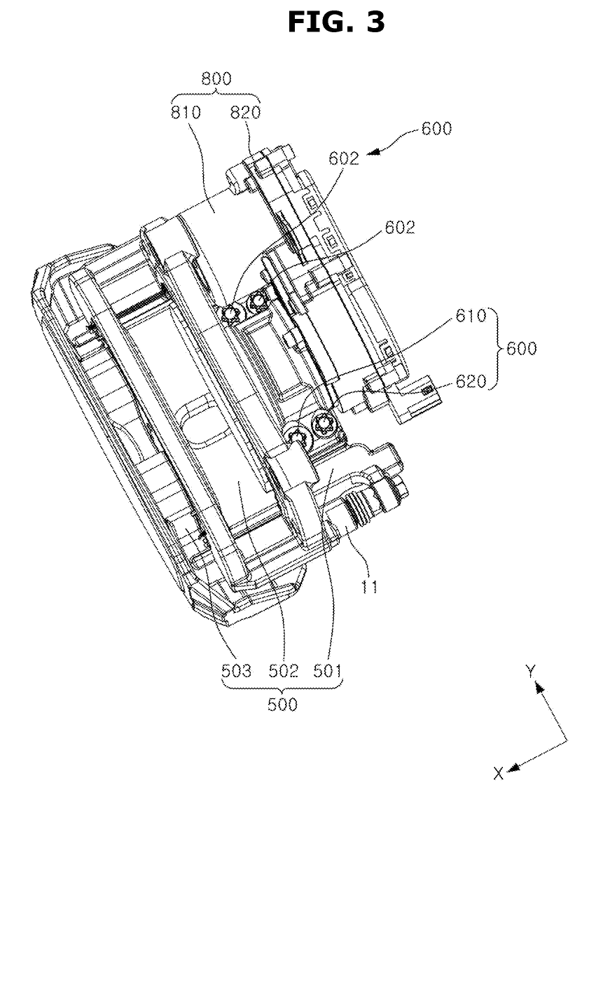

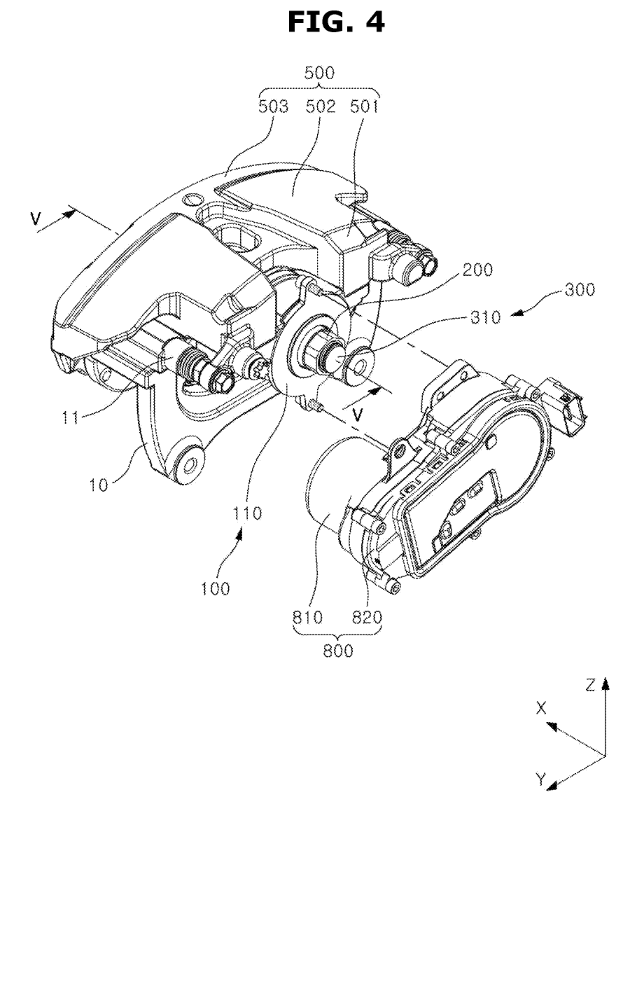

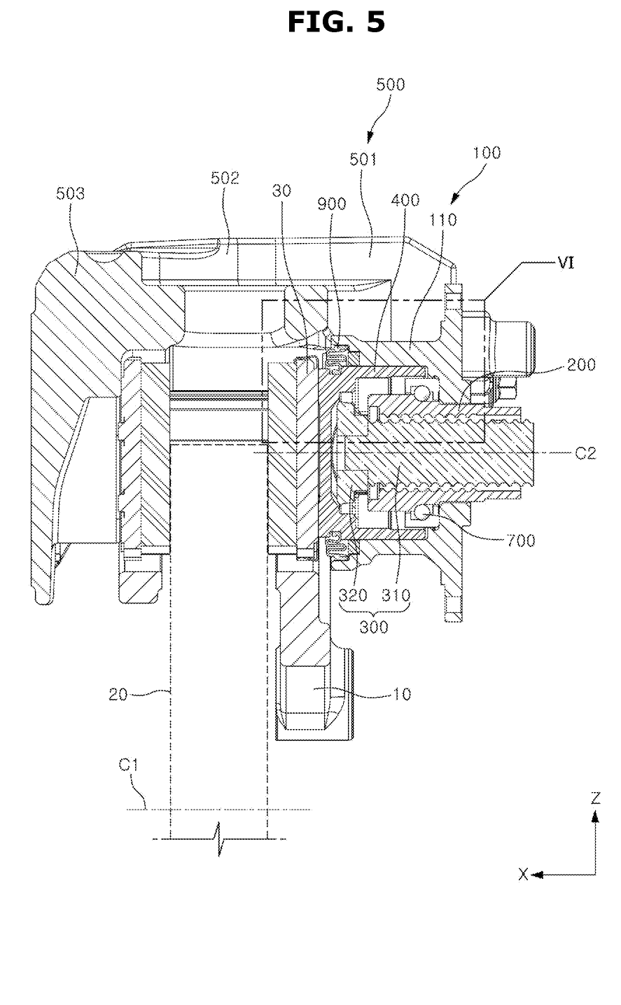

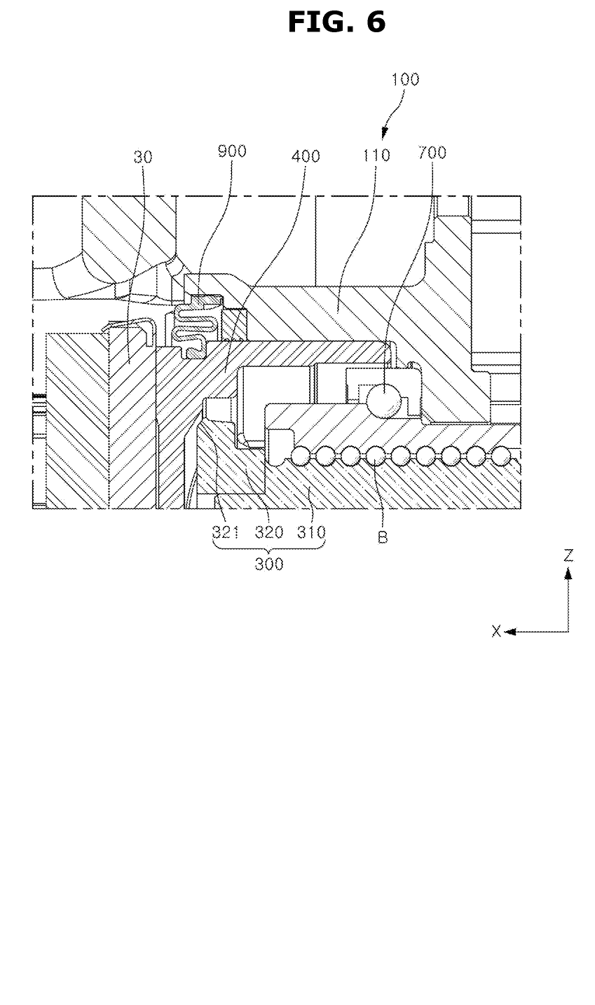

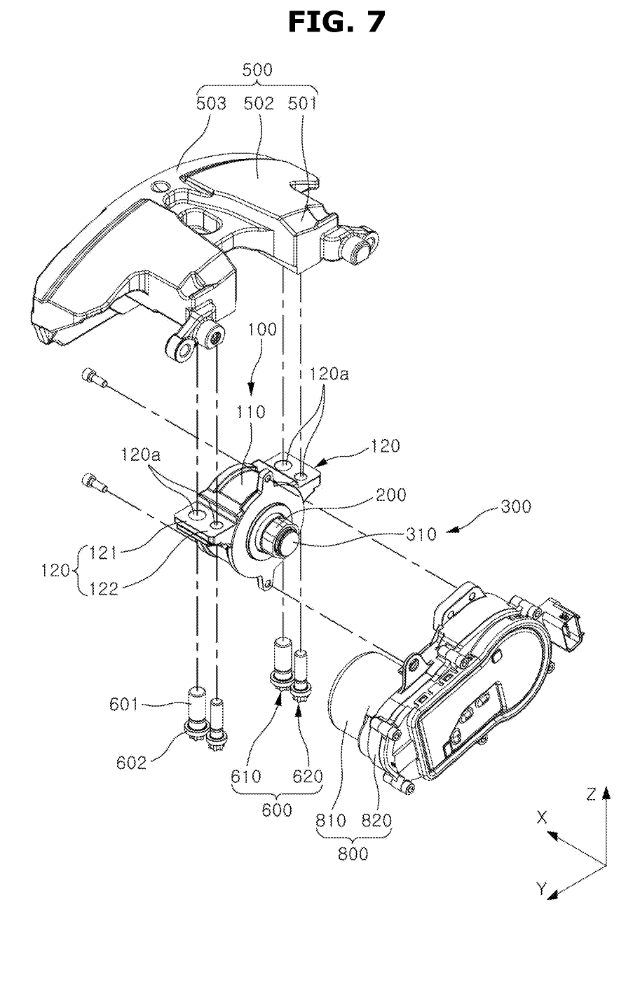

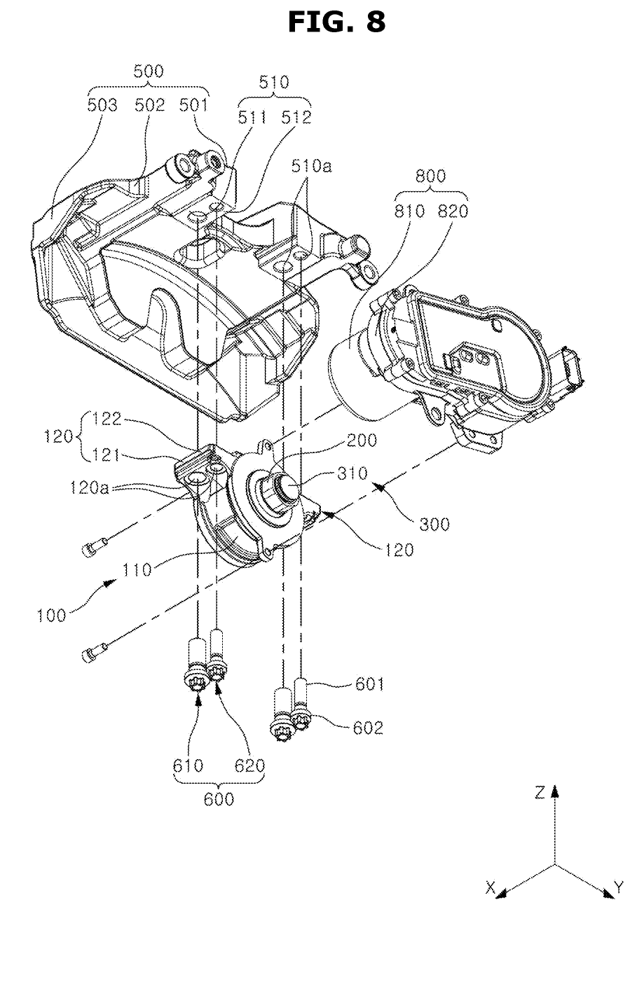

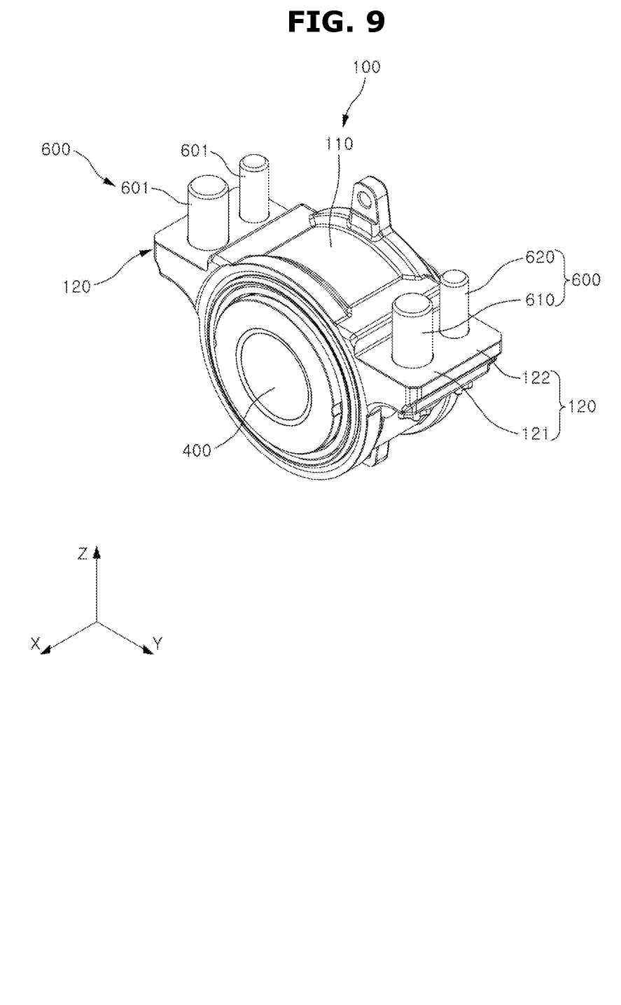

FIGS. 1 and 2 are perspective views of a brake apparatus for a vehicle, which are viewed from an upper side, according to a first embodiment of the present disclosure. FIG. 3 is a diagram of the brake apparatus for a vehicle, which is viewed from a lower side, according to the first embodiment of the present disclosure. FIG. 4 is an exploded perspective view illustrating the brake apparatus for a vehicle according to the first embodiment of the present disclosure. FIG. 5 is a cross-sectional view taken along line V-V in FIG. 4. FIG. 6 is a partially enlarged view of FIG. 5. FIG. 7 is an exploded perspective view of the brake apparatus for a vehicle, which is viewed from an upper side, according to the first embodiment of the present disclosure. FIG. 8 is an exploded perspective view of the brake apparatus for a vehicle, which is viewed from a lower side, according to the first embodiment of the present disclosure. FIG. 9 is a perspective view illustrating a cylinder according to the first embodiment of the present disclosure.

Referring to FIGS. 1 to 9, the brake apparatus for a vehicle according to the first embodiment of the present disclosure includes a cylinder 100, a nut screw 200, a bolt screw 300, a piston 400, a caliper body 500, and a fastening member 600, and is described as follows.

Hereinafter, a first direction may refer to a direction toward which an X axis is directed on the basis of FIGS. 1 to 3. A second direction may refer to a direction toward which a Z axis is directed on the basis of FIGS. 1 to 3. A third direction may refer to a direction toward which a Y axis is directed on the basis of FIGS. 1 to 3.

The cylinder 100 may be combined with the caliper body 500. The cylinder 100 may be detachably combined with the caliper body 500 by the fastening member 600. The cylinder 100 may be provided in plurality. The plurality of cylinders 100 may be disposed to be spaced apart from each other in the third direction.

The cylinder 100 according to the present embodiment may include a cylinder body part 110 and a flange part 120.

The cylinder body part 110 forms an overall outward appearance of the cylinder 100, and may be formed in a hollow shape in which the inside of the cylinder body part 110 is empty. The cylinder body part 110 may be formed in a cylindrical shape in which one side of the cylinder body part 110 is opened.

The opened side of the cylinder body part 110 may be disposed to face any one of a pair of brake pads 30. The cylinder body part 110 may include a cast iron or aluminum material.

The opened side of the cylinder body part 110 may be disposed to face the brake pad 30 that is spaced apart from the brake disk 20 in a direction opposite to the first direction, among the pair of brake pads 30. The opened side of the cylinder body part 110 may be spaced apart from the brake pad 30, which is spaced apart from the brake disk 20 in the direction opposite to the first direction, at a set interval.

A central axis C2 of the cylinder body part 110 that is parallel to the first direction may be disposed in parallel to a central axis C1 of the brake disk 20 that is parallel to the first direction. The central axis C2 of the cylinder body part 110 may be spaced apart from the central axis C1 of the brake disk 20 in the second direction.

The second direction may be exemplified as a direction that is perpendicular to the first direction and that is directed from the central axis C1 of the brake disk 20 to the central axis C2 of the cylinder body part 110. The second direction may be a direction that is perpendicular to the ground when the bottom of a bridge 101 is disposed to be parallel to the ground, that is, a direction that rises in the Z axis direction on the basis of FIG. 5.

The flange part 120 may be formed in the outer circumferential surface of the cylinder body part 110 in a way to protrude therefrom. The flange part 120 may protrude in the third direction from the outer circumferential surface of the cylinder body part 110. The flange part 120 may include a through-hole 120a.

The through-hole 120a may be formed to penetrate the flange part 120 in the second direction. A part of the fastening member 600 may pass through the through-hole 120a. A screw thread may be formed in the inner circumferential surface of the through-hole 120a. Accordingly, a body part 601 of the fastening member 600 that passes through the through-hole 120a may be threadedly engaged with the through-hole 120a.

The through-hole 120a may be provided in plurality. The plurality of through-holes 120a may be disposed to be spaced apart from each other in a direction parallel to the first direction, that is, in the direction of the central axis C2 of the cylinder body part 110. The plurality of through-holes 120a may be formed to have different diameters.

The flange part 120 according to the present embodiment may be disposed to be spaced apart from each other in a plural number in the circumferential direction of the cylinder body part 110. For example, the pair of flange parts 120 may be disposed to be spaced apart from each other in a direction parallel to the third direction.

The flange part 120 according to the present embodiment may include a first flange part 121 and a second flange part 122.

The first flange part 121 and the second flange part 122 may be disposed in the direction parallel to the first direction. A first fastening member 610 may penetrate the first flange part 121.

The second flange part 122 may extend in the direction opposite to the first direction from the first flange part 121. The second flange part 122 may be disposed in the direction opposite to the first direction from the first flange part 121. A second fastening member 620 may penetrate the second flange part 122.

The caliper body 500 according to the present embodiment may include a tapped portion 510 that faces the flange part 120. The tapped portion 510 may be formed on the inner surface of a main body part 501 of the caliper body 500 toward the cylinder 100. The tapped portion 510 may come into contact with the flange part 120.

The tapped portion 510 may include a tapped hole 510a with which the fastening member 600 is combined. The tapped hole 510a may be formed to have a shape of a groove that is concavely formed in the tapped portion 510 in the first direction or may be formed to have a shape of a hole that penetrates the tapped portion 510 in the first direction.

A screw thread may be formed in the inner surface of the tapped hole 510a. Accordingly, the body part 601 of the fastening member 600 that passes through the through-hole 120a may be threadedly engaged with the tapped hole 510a.

The tapped portion 510 according to the present embodiment may include a first tapped portion 511 and a second tapped portion 512.

A first tapped portion 511 and a second tapped portion 512 may be disposed in the direction parallel to the first direction. The first tapped portion 511 may come into contact with the first flange part 121.

The second tapped portion 512 may extend in the direction opposite to the first direction from the first tapped portion 511. The second tapped portion 512 may be disposed in the direction opposite to the first direction from the first tapped portion 511. The second tapped portion 512 may come into contact with the second flange part 122.

The nut screw 200 is rotatably disposed in the cylinder 100, and may be connected to the bolt screw 300. A bearing 700 that rotatably supports the nut screw 200 may be installed within the cylinder 100. The bearing 700 may be combined with the nut screw 200. The bearing 700 may be press-fitted within the cylinder 100. The bearing 700 may be exemplified as a ball bearing that is provided between the cylinder 100 and the nut screw 200.

The nut screw 200 may be formed in a hollow shape in which the nut screw 200 has the inside emptied and both ends opened. The nut screw 200 may be disposed within the cylinder 100. The central axis of the nut screw 200 that is parallel to the first direction may be placed on the same axis line as the central axis C2 of the cylinder 100.

One side (i.e., the left side on the basis of FIG. 5) of the nut screw 200 may be disposed to face the inner surface of the piston 400 by being spaced apart from the inner surface of the piston 400 at a set interval. The other side (i.e., the right side on the basis of FIG. 5) of the nut screw 200 may protrude to the outside of the cylinder 100 through a closed side of the cylinder 100.

The other side of the nut screw 200 may be connected to a driving part 800. The driving part 800 is combined with the cylinder 100, and may generate a driving force so that the piston 400 can reciprocate. The driving part 800 may include an actuator 810 and electric power transfer means (not illustrated). The electric power transfer means may be accommodated within the housing 820.

A housing 820 may be disposed on the outside of the cylinder 100, and may have one surface disposed to face the closed side of the cylinder 100. The housing 820 may be bolting-combined with the cylinder 100.

The actuator 810 is combined with the housing 820 and may generate a rotational force. The actuator 810 may be exemplified as various types of electric motors which can generate a rotational force by receiving power from the battery (not illustrated) of a vehicle. The central axis of the actuator 810 that is parallel to the first direction may be disposed in parallel to the central axis C2 of the cylinder 100 or may be disposed to be spaced apart from the central axis C2 of the cylinder 100.

The nut screw 200 may be connected to electric power transfer means that is supplied with a rotational force from the actuator 810. The electric power transfer means may transfer the rotational force of the actuator 810 to the nut screw 200. The electric power transfer means may include a plurality of gears that are sequentially engaged and combined between the actuator 810 and the nut screw 200. However, the electric power transfer means is not limited to such a construction, and may be designed and changed as various types of electric power transfer means which can rotate the nut screw 200 by receiving a rotational force from the actuator 810.

When the actuator 810 operates, the nut screw 200 may receive a rotational force that is generated by the actuator through the electric power transfer means, and may be rotated in a clockwise direction or a counterclockwise direction around the central axis that is parallel to the first direction.

The nut screw 200 may have an inner surface disposed to face the outer surface of the bolt screw 300. A ball rail that is seated on the circumference of a ball member B having a spherical shape on one side thereof may be formed in the inner circumferential surface of the nut screw 200. Such a ball rail may extend in a spiral form in the length direction of the nut screw 200, that is, in the direction parallel to the first direction, and may provide the circulation path of the ball member B.

The bolt screw 300 may be moved in the first direction or the direction opposite to the first direction within the cylinder 100 while operating in conjunction with the rotation of the nut screw 200. The bolt screw 300 may be disposed within the nut screw 200. The bolt screw 300 may be disposed to penetrate both ends of the nut screw 200.

The bolt screw 300 may pressurize the piston 400 in the first direction as the bolt screw 300 is moved in the first direction, and may release the pressing force applied to the piston 400 as the bolt screw 300 in the direction opposite to the first direction.

The bolt screw 300 according to the present embodiment may include a bolt body part 310 and a bolt head part 320.

The bolt body part 310 may be formed in a bar or pole shape in which the bolt body part 310 has an approximately circular cross section. The bolt body part 310 may be disposed within the cylinder 100, and may have a central axis that is parallel to the first direction placed on the same axis line as the central axis C2 of the cylinder 100. The bolt body part 310 may be combined with the nut screw 200 through the medium of the ball member B.

A ball rail on, which the circumference of the ball member B on the other side thereof is seated, may be formed on the outer circumferential surface of the bolt body part 310. Such a ball rail may extend in a spiral form in the length direction of the bolt body part 310, that is, in the direction parallel to the first direction, and may provide the circulation path of the ball member B. Accordingly, when the nut screw 200 is rotated, the bolt body part 310 may be moved in the first direction or the direction opposite to the first direction by a circulation movement of the ball member B.

The bolt head part 320 may be disposed between the bolt body part 310 and the piston 400. The bolt head part 320 may be formed to have an approximately circular cross section. The bolt head part 320 may be inserted into the piston 400. The bolt head part 320 may be disposed to face the inner surface of the piston 400 by being spaced apart from the inner surface of the piston 400 at a set interval.

The bolt head part 320 may pressurize the piston 400. The bolt head part 320 may pressurize the piston 400 or release pressurization for the piston 400 in the first direction according to the moving direction of the bolt body part 310.

The bolt head part 320 may be provided on one side (i.e., the left side on the basis of FIG. 5) the bolt body part 310 that is disposed to face the piston 400.

The diameter of the bolt head part 320 may be formed to be greater than the diameter of the bolt body part 310. The outside diameter of the bolt head part 320 may be formed to be greater than the inside diameter of the nut screw 200. Accordingly, the bolt head part 320 may protrude from the nut screw 200.

The bolt head part 320 may come into contact with the inner surface of the piston 400 as the bolt body part 310 is moved in the first direction, and may pressurize the piston 400 in the first direction.

As the bolt body part 310 is moved in the direction opposite to the first direction, the bolt head part 320 may be separated from the inner surface of the piston 400 and release a pressing force that is applied to the piston 400.

The bolt head part 320 according to the present embodiment may further include a pressurization part 321 that comes into contact with the inner surface of the piston 400.

The pressurization part 321 may be formed in the bolt head part 320 in a way to protrude therefrom. The pressurization part 321 may protrude from the outer circumferential surface of the bolt head part 320, and may be formed in the circumferential direction of the bolt head part 320.

The pressurization part 321 may be provided on one side (i.e., the left side on the basis of FIG. 5) of the bolt head part 320 toward the direction in which the piston 400 is placed.

The piston 400 may be installed in the cylinder 100 in a way to be movable in the first direction or the direction opposite to the first direction. The piston 400 may be disposed within the cylinder 100. The piston 400 may be formed in a hollow shape in which one side of the piston 400 is opened. A closed side of the piston 400 may be disposed toward the brake pad 30 that is disposed to face the cylinder 100.

The opened side of the piston 400 may be disposed toward the internal space of the cylinder 100. The outer surface of the piston 400 may be slidably supported by the inner surface of the cylinder 100. In contrast, the outer surface of the piston 400 may form a gap by being spaced apart from the inner surface of the cylinder 100 at a set distance. The bolt head part 320 of the bolt screw 300 may be inserted into the piston 400.

As the piston 400 is moved in the first direction, the piston 400 may protrude to the outside of the cylinder 100, and may pressurize the brake pad 30 that is disposed to face the cylinder 100 toward the brake disk 20.

A piston boot 900 that prevents the introduction of an external alien substance and that water-tightly seals the inside of the cylinder 100 may be installed within the cylinder 100 according to the present embodiment. The piston boot 900 may be installed between the cylinder 100 and the piston 400. The piston boot 900 is combined with the piston 400 and may be press-fitted into the cylinder 100.

The piston boot 900 may be formed to surround the piston 400. The piston boot 900 may include an elastically deformable material. For example, the piston boot 900 may be fabricated to include a rubber material. The piston boot 900 may be formed to have a ruffled shape.

The caliper body 500 may form a schematic outward appearance of the brake apparatus for a vehicle according to the present embodiment, and may generally support the cylinder 100 and the driving part 800. The caliper body 500 may be disposed on the outside of the cylinder 100 and provided to surround a part of the cylinder 100. The caliper body 500 may include a cast iron or aluminum material.

The caliper body 500 according to the present embodiment may include a main body part 501, a bridge part 502, and a plate part 503.

The main body part 501 is seated on the cylinder 100, and may be provided to surround a part of the outer circumferential surface of the cylinder 100. Incidentally, the inner circumferential surface of the main body part 501 that comes into contact with the cylinder 100 may be formed to have a concave shape in which the inner circumferential surface has the same curvature as the outer circumferential surface of the cylinder 100.

The bridge part 502 forms an outward appearance of a central part of the caliper body 500, and may support the main body part 501 and the plate part 503. The bridge part 502 may be connected to a carrier 10 that is fixed to a guide rod 11 through the medium of a knuckle (not illustrated) of a vehicle. The bridge part 502 may be connected to the carrier 10 in the first direction or a direction opposite to the first direction in a way to reciprocate.

The bottom of the bridge part 502 may be disposed to face the circumferential surface of the brake disk 20 by being spaced apart from the circumferential surface of the brake disk 20 at a set interval. Both ends of the bridge part 502 may extend in the first direction and the direction opposite to the first direction, respectively, on the basis of the brake disk 20.

The pair of brake pads 30 may be disposed under the bridge part 502. The pair of brake pads 30 may be disposed to face each other with the brake disk 20 interposed therebetween. A friction pad including a material having a high friction coefficient, such as rubber, may be attached to one surface of the brake pad 30 that faces the brake disk 20.

The plate part 503 may extend downward from one side of the bridge part 502. The plate part 503 may be disposed to face any one of the pair of brake pads 30.

When the bridge part 502 is moved in the direction in which the main body part 501 is placed, the plate part 503 may pressurize the brake pad 30 spaced apart from the brake disk 20 toward the brake disk.

The caliper body 500 according to the present embodiment may include the tapped portion 510 that faces the flange part 120. The tapped portion 510 may be formed on the inner surface of the main body part 501 of the caliper body 500 toward the cylinder 100. The tapped portion 510 may come into contact with the flange part 120.

The tapped portion 510 may include a tapped hole 510a with which the fastening member 600 is combined. The tapped hole 510a may be formed to have a shape of a groove that is concavely formed in the tapped portion 510 in the first direction or may be formed to have a shape of a hole that penetrates the tapped portion 510 in the first direction.

A screw thread may be formed in the inner surface of the tapped hole 510a. Accordingly, the screw thread may be threadedly engaged with a body part 601 of the fastening member 600 that passes through the through-hole 120a.

The tapped portion 510 according to the present embodiment may include the first tapped portion 511 and the second tapped portion 512.

The first tapped portion 511 and the second tapped portion 512 may be disposed in the direction parallel to the first direction. The first tapped portion 511 may come into contact with the first flange part 121.

The second tapped portion 512 may extend in the direction opposite to the first direction from the first tapped portion 511. The second tapped portion 512 may be disposed in the direction opposite to the first direction from the first tapped portion 511. The second tapped portion 512 may come into contact with the second flange part 122.

The fastening member 600 may fasten the cylinder 100 to the caliper body 500. The direction in which the fastening member 600 is fastened according to the present embodiment may be directed toward a direction parallel to the second direction. The fastening member 600 may fasten the cylinder 100 and the caliper body 500 in the direction parallel to the second direction.

In an embodiment, the fastening member 600 may be fastened to the tapped portion 510 through the flange part 120. In another embodiment, the fastening member 600 may be fastened to the flange part 120 through the tapped portion 510.

The fastening member 600 may be exemplified as a bolt, including the body part 601 having a screw thread formed on an outer circumferential surface thereof and a head part 602 provided on one side of the body part 601 and having a diameter greater than the diameter of the body part 601.

A part of the fastening member 600 may pass through the through-hole 120a. The diameter of the through-hole 120a may be formed to be greater than the body part 601 of the fastening member 600 and to be smaller than the head part 602 of the fastening member 600. Accordingly, only the body part 601 of the fastening member 600 may pass through the through-hole 120a.

The fastening member 600 according to the present embodiment may include the first fastening member 610 and the second fastening member 620.

The first fastening member 610 and the second fastening member 620 may be disposed to be spaced apart from each other in the direction parallel to the first direction.

The first fastening member 610 may be combined with a first tapped portion 511 through the first flange part 121. The body part 601 of the first fastening member 610 may be threadedly engaged with the tapped hole 510a that is formed in the first tapped portion 511 through the through-hole 120a formed in the first flange part 121.

The second fastening member 620 may be disposed to be spaced apart from the first fastening member 610 in the direction opposite to the first direction. The second fastening member 620 may be combined with the second tapped portion 512 through the second flange part 122. The body part 601 of the second fastening member 620 may be threadedly engaged with the tapped hole 510a that is formed in the second tapped portion 512 through the through-hole 120a formed in the second flange part 122.

The diameter of the first fastening member 610 and the diameter of the second fastening member 620 according to the present embodiment may be formed to be different. For example, the diameter of the first fastening member 610 may be formed to be greater than the diameter of the second fastening member 620. Incidentally, the diameter of the body part 601 of the first fastening member 610 that passes through the through-hole 120a may be formed to be greater than the diameter of the second fastening member 620 of the body part 601.

As the diameter of the first fastening member 610 is formed to be greater than the diameter of the second fastening member 620, when the braking force of the caliper body 500 is generated, a deformation of the caliper body 500 can be prevented because a shearing load that is generated in the axial direction of the cylinder 100, that is, in the direction parallel to the first direction, and a vertical load that is generated in a direction orthogonal to the axial direction of the cylinder 100, that is, in the direction parallel to the second direction, can be supported.

When the braking force of the caliper body 500 is generated, a deformation that a distance between the main body part 501 and the plate part 503 is widened on the basis of the bridge part 502 can be prevented because the shearing load and the vertical load are applied to the caliper body 500.

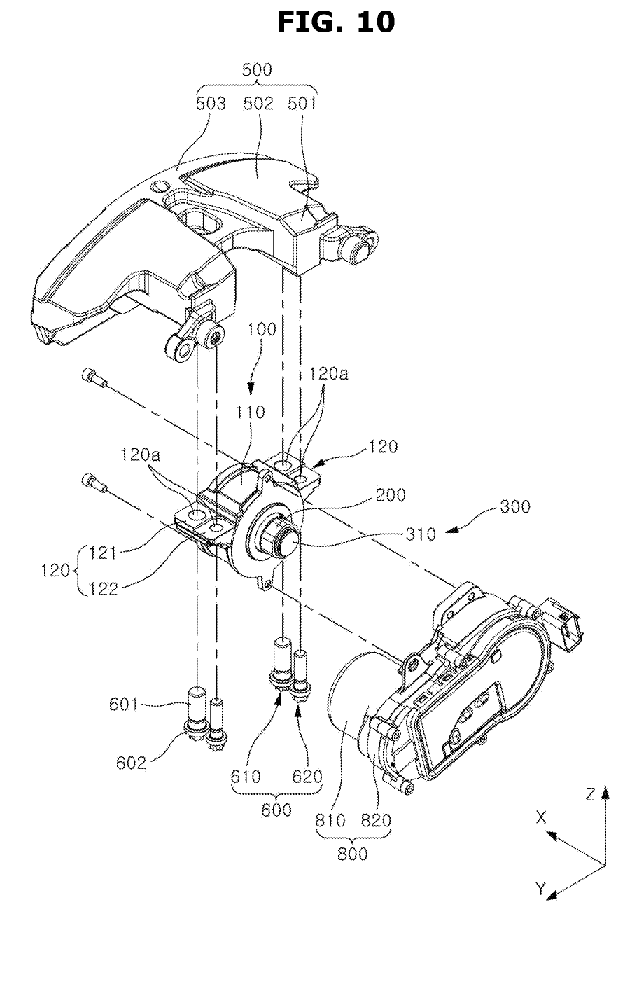

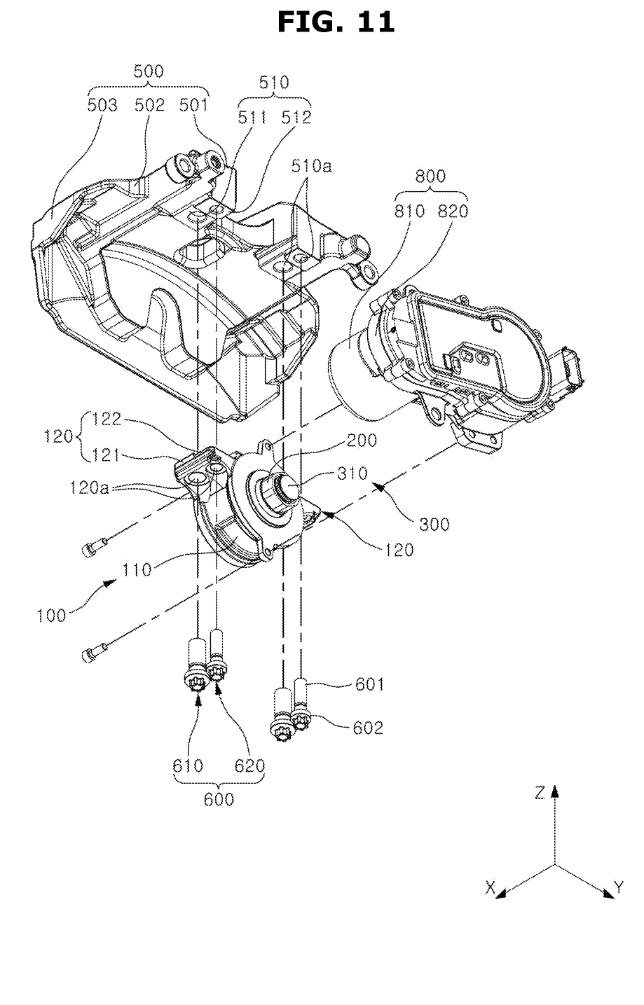

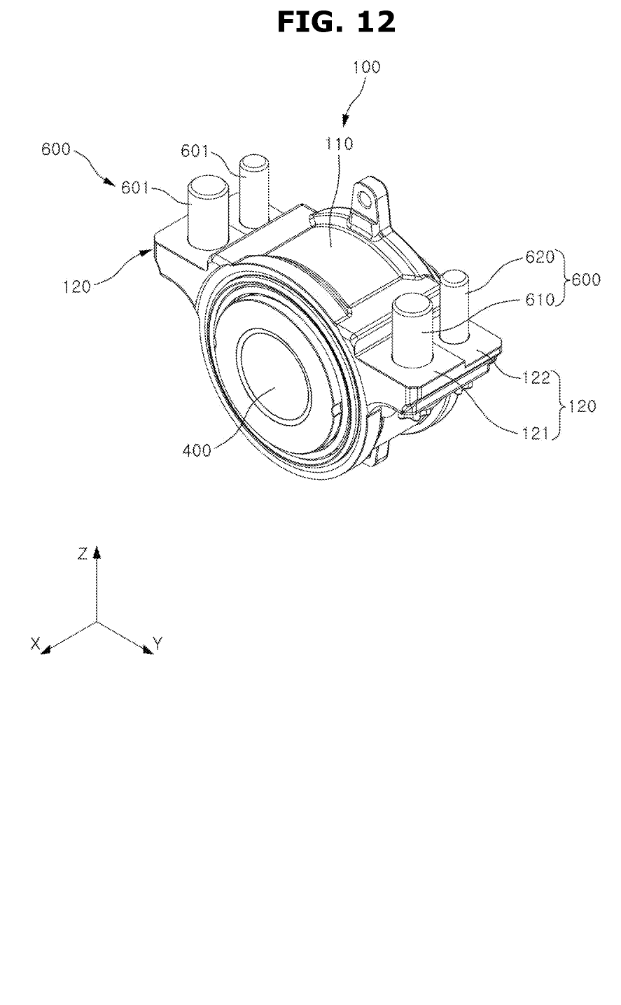

FIG. 10 is an exploded perspective view of a brake apparatus for a vehicle, which is viewed from an upper side, according to a second embodiment of the present disclosure. FIG. 11 is an exploded perspective view of the brake apparatus for a vehicle, which is viewed from an upper side, according to the second embodiment of the present disclosure. FIG. 12 is a perspective view illustrating a cylinder according to the second embodiment of the present disclosure.

Referring to FIGS. 10 to 12, the brake apparatus for a vehicle according to the second embodiment of the present disclosure may include a cylinder 100, a nut screw 200, a bolt screw 300, a piston 400, a caliper body 500, and a fastening member 600.

In describing the brake apparatus for a vehicle according to the second embodiment of the present disclosure, other embodiments of the cylinder and the caliper body in the brake apparatus for a vehicle according to the first embodiment of the present disclosure are described.

With respect to the remaining components of the brake apparatus for a vehicle according to the second embodiment of the present disclosure, the descriptions of components of the brake apparatus for a vehicle according to the first embodiment of the present disclosure may be applied without any change.

The cylinder 100 according to the present embodiment may include a cylinder body part 110 and a flange part 120.

The flange part 120 may be formed in the outer circumferential surface of the cylinder body part 110 in a way to protrude therefrom. The flange part 120 may protrude in the third direction from the outer circumferential surface of the cylinder body part 110. The flange part 120 may include a through-hole 120a.

The flange part 120 according to the present embodiment may include a first flange part 121 and a second flange part 122.

The first flange part 121 and the second flange part 122 may be disposed in the direction parallel to the first direction. A first fastening member 610 may penetrate the first flange part 121.

The second flange part 122 may extend in the direction opposite to the first direction from the first flange part 121. The second flange part 122 may be disposed in the direction opposite to the first direction from the first flange part 121. A second fastening member 620 may penetrate the second flange part 122.

The height of the first flange part 121 and the height of the second flange part 122, which are parallel to the second direction, may be formed to be different. The flange part 120 according to the present embodiment may be formed to be stepped in the direction parallel to the first direction. For example, the height of the second flange part 122 that is parallel to the second direction may be formed to be lower than the height of the first flange part 121 that is parallel to the second direction. Incidentally, the second flange part 122 may be stepped and extended in the direction opposite to the first direction from the first flange part 121.

The caliper body 500 according to the present embodiment may include a tapped portion 510 that faces the flange part 120. The tapped portion 510 may be formed on the inner surface of a main body part 501 of the caliper body 500 toward the cylinder 100. The tapped portion 510 may come into contact with the flange part 120.

The tapped portion 510 may include a tapped hole 510a with which the fastening member 600 is combined. The tapped hole 510a may be formed to have a shape of a groove that is concavely formed in the tapped portion 510 in the first direction or may be formed to have a shape of a hole that penetrates the tapped portion 510 in the first direction.

A screw thread may be formed in the inner surface of the tapped hole 510a. Accordingly, the body part 601 of the fastening member 600 that passes through the through-hole 120a may be threadedly engaged with the tapped hole 510a.

The tapped portion 510 according to the present embodiment may include a first tapped portion 511 and a second tapped portion 512.

The first tapped portion 511 and the second tapped portion 512 may be disposed in the direction parallel to the first direction. The first tapped portion 511 may come into contact with the first flange part 121.

The second tapped portion 512 may extend in the direction opposite to the first direction from the first tapped portion 511. The second tapped portion 512 may be disposed in the direction opposite to the first direction from the first tapped portion 511. The second tapped portion 512 may come into contact with the second flange part 122.

The height of the first tapped portion 511 and the height of the second tapped portion 512, which are parallel to the second direction, may be formed to be different. The tapped portion 510 according to the present embodiment may be formed to be stepped in the direction parallel to the first direction. For example, the height of the first tapped portion 511 that is parallel to the second direction may be formed to be lower than the height of the second tapped portion 512 that is parallel to the second direction. Incidentally, the first tapped portion 511 may be stepped and extended in the first direction from the second tapped portion 512.

The stepped surface formed between the first flange part 121 and the second flange part 122 and the stepped surface formed between the first tapped portion 511 and the second tapped portion 512 are provided to adjoin each other. Accordingly, a deformation of the caliper body 500 can be prevented because a shearing load that is generated in the axial direction of the cylinder 100, that is, in the direction parallel to the first direction, and a vertical load that is generated in the direction orthogonal to the axial direction of the cylinder 100, that is, in the direction parallel to the second direction, can be supported when the braking force of the caliper body 500 is generated.

A deformation, such as the widening of a gap between the main body part 501 and the plate part 503 on the basis of the bridge part 502, because the shearing load and the vertical load are applied to the caliper body 500 when the braking force of the caliper body 500 is generated, can be prevented.

The brake apparatus for a vehicle according to an embodiment of the present disclosure can secure the stiffness of the caliper body 500 by minimizing a load that is applied to the fastening member 600 because the plurality of fastening members 600 that fastens the cylinder 100 and the caliper body 500 supports a shearing load when the braking force of the caliper body 500 is generated.

The brake apparatus for a vehicle according to an embodiment of the present disclosure can achieve a reduction in the size of the cylinder 100, quality stabilization through the publicization of all KIT specifications, a reduction of investment costs, and the enhancement of competitiveness attributable to the maximization of output because the cylinder 100 including the ball screw and the piston 400 can be composed of a compact modularization KIT and assembled with the caliper body 500.

The brake apparatus for a vehicle according to an embodiment of the present disclosure can minimize the length in the axial direction thereof by applying the nut-driven type in which a rotational motion of the nut is changed into a linear motion of the screw.

The brake apparatus for a vehicle according to an embodiment of the present disclosure can reduce weight through material dualization and a reduction of the size.

The brake apparatus for a vehicle according to an embodiment of the present disclosure can improve profitability due to a productivity increase and a production efficiency increase attributable to the improvement of a process and assembly.

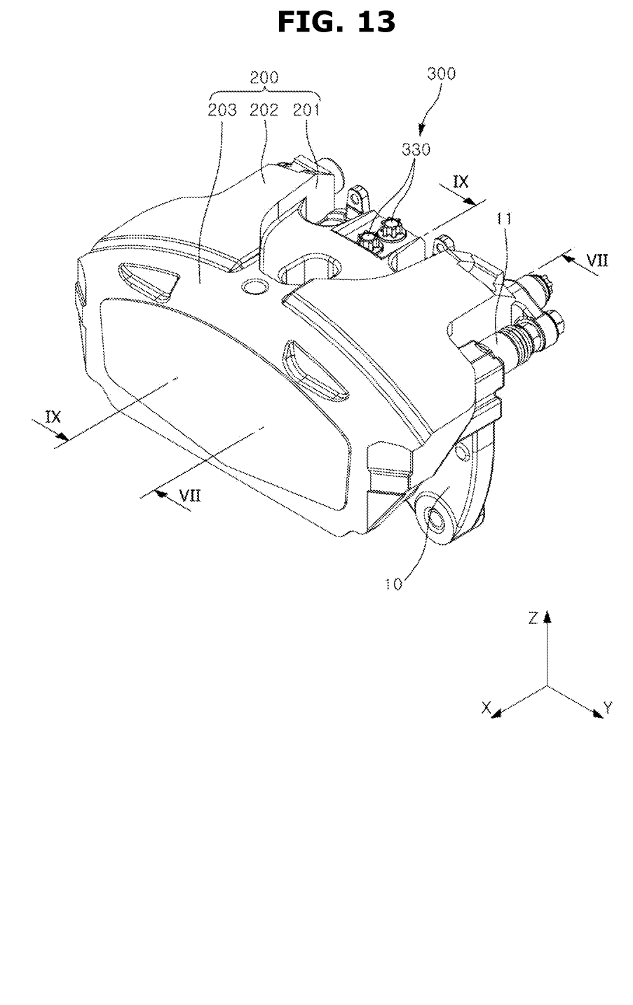

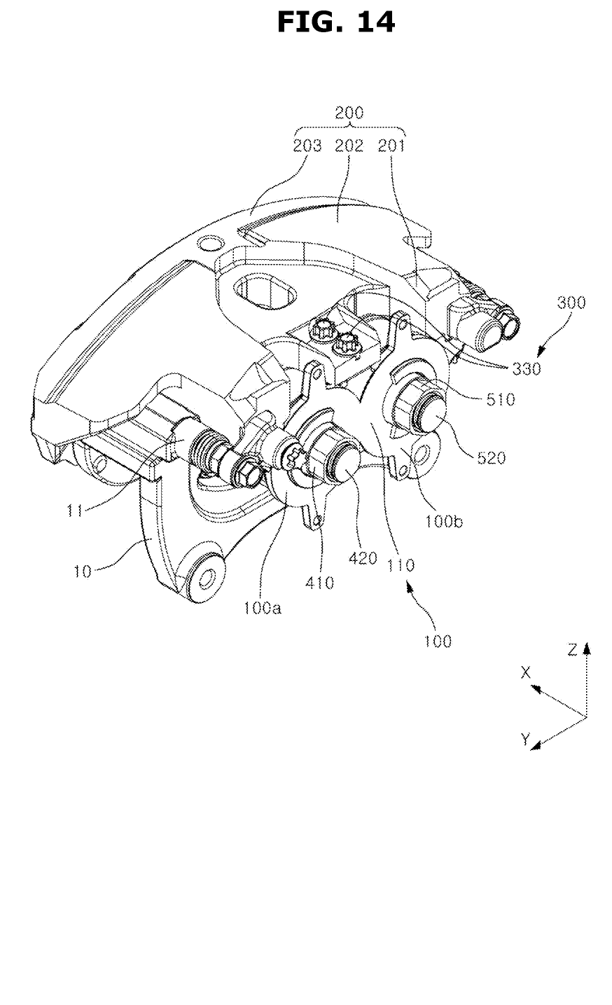

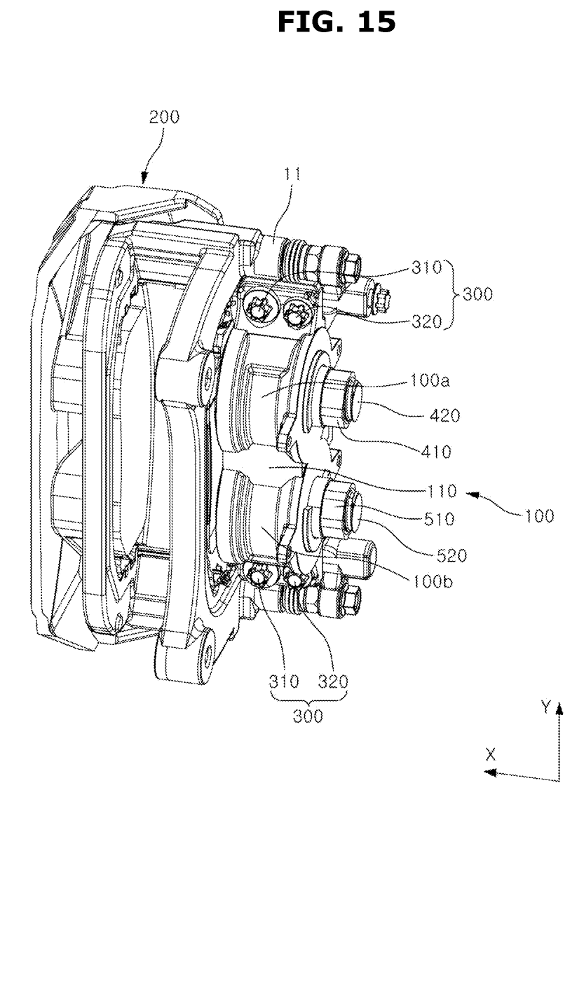

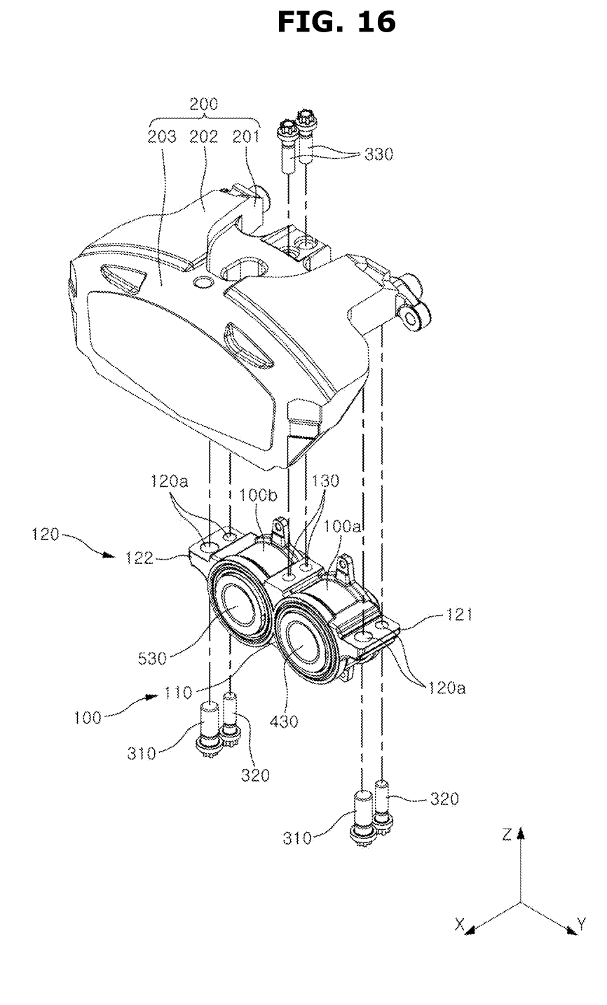

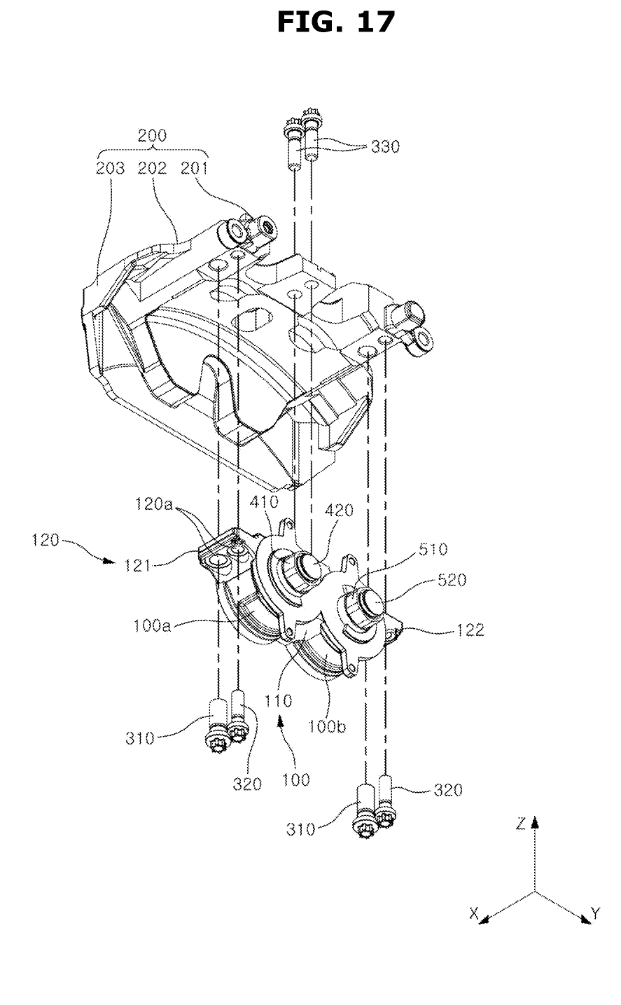

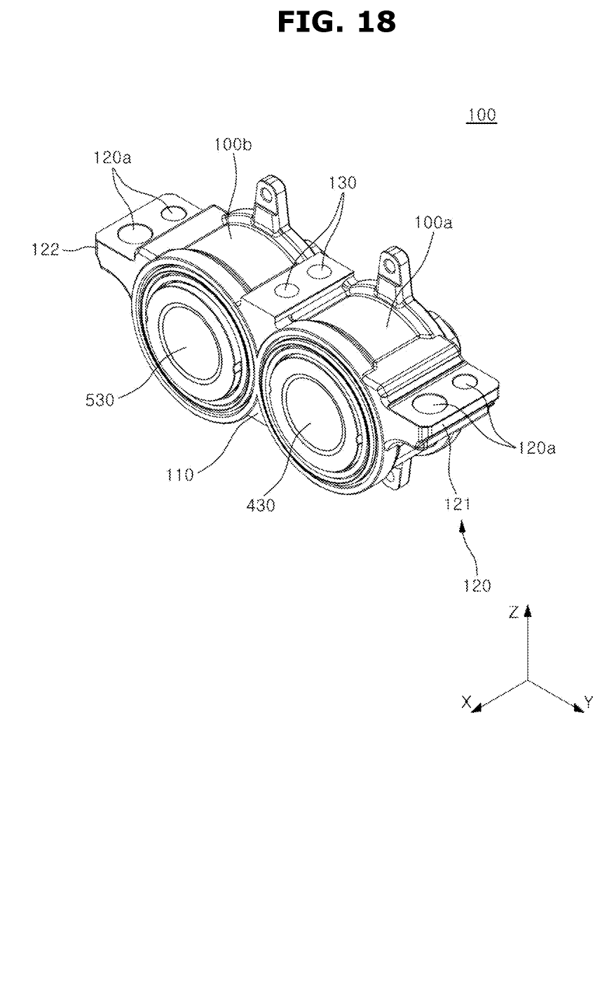

FIGS. 13 and 14 are perspective views of the brake apparatus for a vehicle according to a third embodiment of the present disclosure, which are viewed from an upper side. FIG. 15 is a perspective view of the brake apparatus for a vehicle, which is viewed from a lower side, according to a third embodiment of the present disclosure. FIG. 16 is an exploded perspective view of the brake apparatus for a vehicle, which is viewed from an upper side, according to the third embodiment of the present disclosure. FIG. 17 is an exploded perspective view of the brake apparatus for a vehicle, which is viewed from a lower side, according to the third embodiment of the present disclosure. FIG. 18 is a perspective view illustrating a cylinder part according to the third embodiment of the present disclosure.

Referring to FIGS. 13 to 18, the brake apparatus for a vehicle according to the third embodiment of the present disclosure includes a cylinder part 100, a caliper body 200, and a fastening member 300.

Hereinafter, a first direction may refer to a direction toward which an X axis is directed on the basis of FIGS. 13 to 15. A second direction may refer to a direction toward which a Z axis is directed on the basis of FIGS. 13 to 15. A third direction may refer to a direction toward which a Y axis is directed on the basis of FIGS. 13 to 15.

The cylinder part 100 may be combined with the caliper body 200. The cylinder part 100 may be detachably combined with the caliper body 200 by the fastening member 300. The cylinder part 100 may include a first cylinder 100a and a second cylinder 100b. The first cylinder 100a and the second cylinder 100b may be integrally formed.

The cylinder part 100 according to the present embodiment may include a cylinder body 110, a flange part 120, and a tapped portion 130.

The cylinder body 110 forms an overall outward appearance of the cylinder part 100, and may include a cast iron or aluminum material. The first cylinder 100a and the second cylinder 100b each including a hollow having the inside emptied may be formed in the cylinder body 110. The first cylinder 100a and the second cylinder 100b may each be formed in a cylindrical shape in which one side of the cylinder has been opened.

The flange part 120 may be formed in the outer circumferential surface of the cylinder body 110 in a way to protrude therefrom. The flange part 120 may protrude in the third direction from the outer circumferential surface of the cylinder body 110. The flange part 120 may include a through-hole 120a.

The through-hole 120a may be formed to penetrate the flange part 120 in a direction parallel to the second direction. A part of the fastening member 300 may pass through the through-hole 120a. A screw thread may be formed in the inner circumferential surface of the through-hole 120a. Accordingly, the fastening member 300 that passes through the through-hole 120a may be threadedly engaged with the through-hole 120a.

The through-hole 120a may be provided in plurality. The plurality of through-hole 120a may be disposed to be spaced apart from each other in the direction parallel to the first direction. The plurality of through-hole 120a may be formed to have different diameters.

The flange part 120 according to the present embodiment may include a first flange part 121 and a second flange part 122.

The first flange part 121 may be provided on one side of the first cylinder 100a. The first flange part 121 may be formed in the outer circumferential surface of the first cylinder 100a in way to protrude therefrom. The first flange part 121 may protrude in a direction parallel to the third direction from the outer circumferential surface of the first cylinder 100a.

The second flange part 122 may be provided on one side of the second cylinder 100b. The second flange part 122 may be formed in the outer circumferential surface of the second cylinder 100b in a way to protrude therefrom. The second flange part 122 may protrude in the direction parallel to the third direction from the outer circumferential surface of the second cylinder 100b.

The first flange part 121 and the second flange part 122 may be disposed to be spaced apart from each other. The first flange part 121 and the second flange part 122 may be spaced apart from each other in the direction parallel to the third direction.

The tapped portion 130 may be provided in the cylinder body 110. The tapped portion 130 may have a shape of a groove that is concavely formed in the outer surface (i.e., a top surface on the basis of FIG. 16) of the cylinder body 110 or may be formed to have a shape of a hole that penetrates the cylinder body 110 in a direction parallel to the second direction.

The fastening member 300 may be combined with the tapped portion 130. A screw thread may be formed in the inner circumferential surface of the tapped portion 130. Accordingly, the fastening member 300 may be threadedly engaged with the tapped portion 130.

The tapped portion 130 may be disposed between the first flange part 121 and the second flange part 122. The tapped portion 130 may be disposed between the first cylinder 100a and the second cylinder 100b. The tapped portion 130 may be provided in plurality. The plurality of tapped portions 130 may be disposed to be spaced apart from each other in the direction parallel to the first direction.

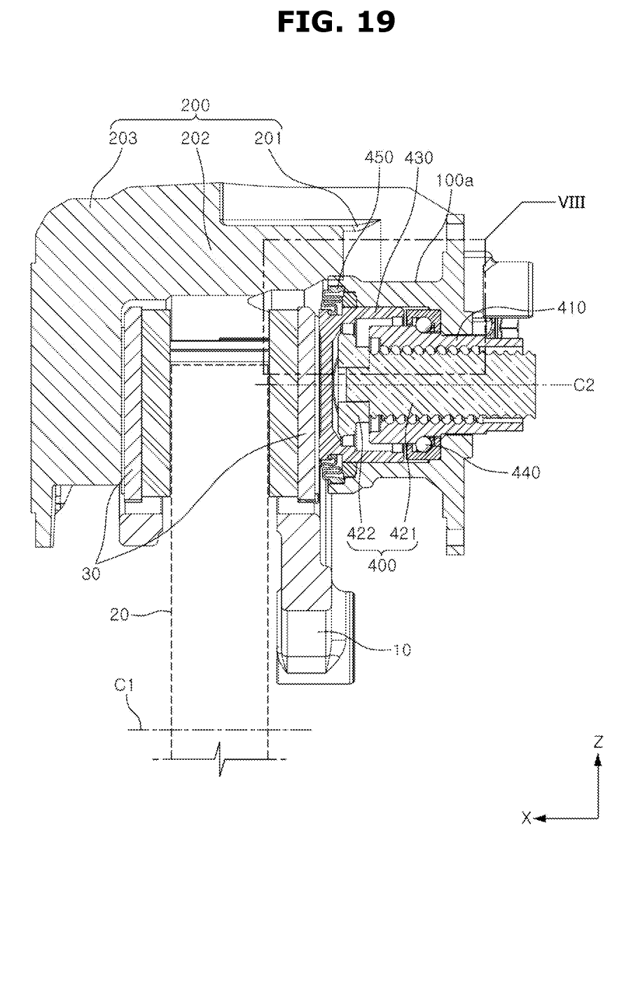

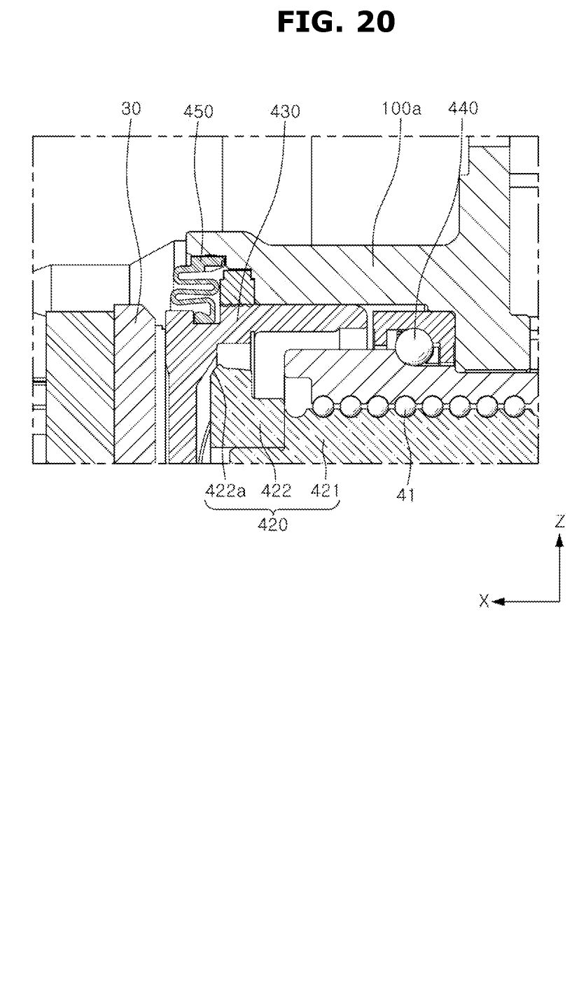

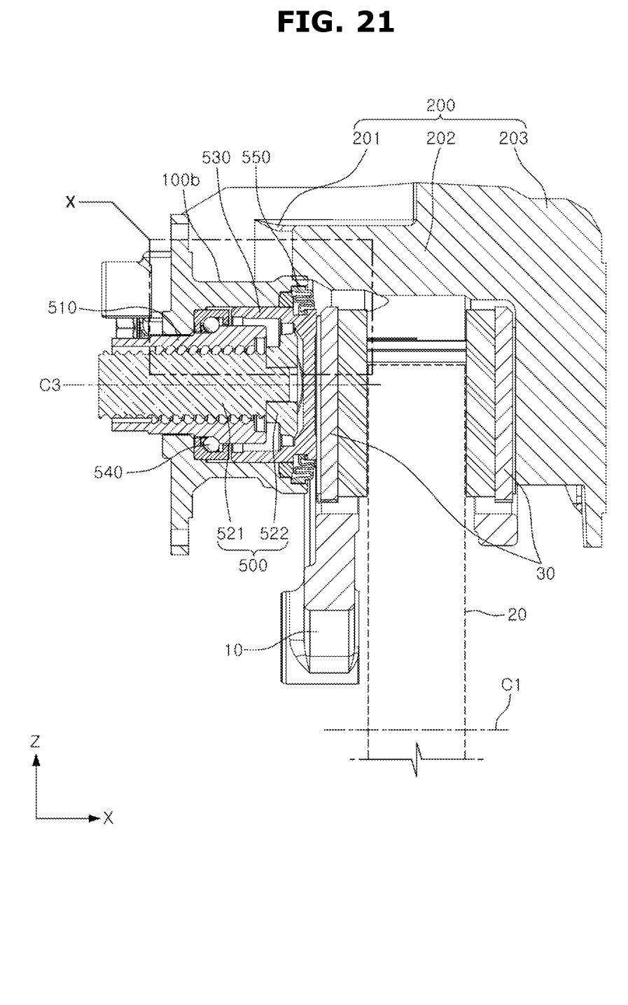

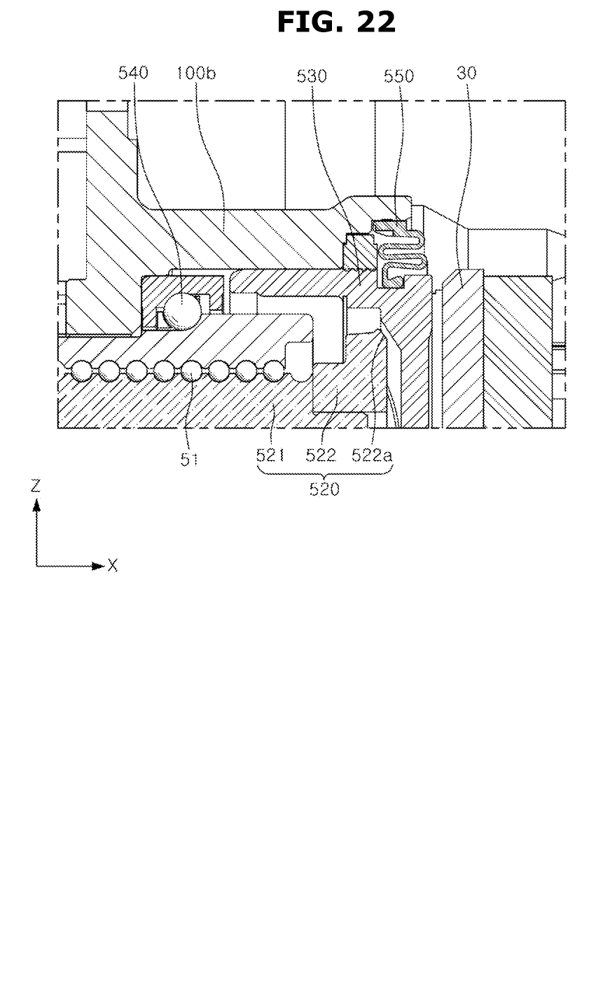

FIG. 19 is a cross-sectional view taken along line VII-VII in FIG. 13. FIG. 20 is an enlarged view of VIII in FIG. 19. FIG. 21 is a cross-sectional view taken along line IX-IX in FIG. 13. FIG. 22 is an enlarged view of X in FIG. 21.

Referring to FIGS. 13 to 22, the caliper body 200 forms a schematic outward appearance of the brake apparatus for a vehicle according to the present embodiment, and may generally support the cylinder part 100. The caliper body 200 is disposed on the outside of the cylinder part 100, and may be provided to surround a part of the cylinder part 100. The caliper body 200 may include a cast iron or aluminum material.

The caliper body 200 according to the present embodiment may include a main body part 201, a bridge part 202, and a plate part 203.

The main body part 201 is seated on the cylinder part 100, and may be provided to surround a part of the outer circumferential surface of the cylinder part 100. Incidentally, the inner circumferential surface of the main body part 201 that comes into contact with the cylinder part 100 may be formed to have a concave shape having the same curvature as the outer circumferential surface of the cylinder part 100.

The bridge part 202 forms an outward appearance of a central part of the caliper body 200, and may support the main body part 201 and the plate part 203. The bridge part 202 may be connected to a carrier 10 that is fixed to a knuckle (not illustrated) of the vehicle through the medium of a guide rod 11. The bridge part 202 may be connected to the carrier 10 in the first direction or a direction opposite to the first direction in a way to be capable of being reciprocated.

The bottom of the bridge part 202 may be disposed to face the circumferential surface of the brake disk 20 by being spaced apart therefrom at a set interval. Both sides of the bridge part 202 may extend in the first direction and the direction opposite to the first direction, respectively, on the basis of the brake disk 20.

A pair of brake pads 30 may be disposed under the bridge part 202. The pair of brake pads 30 may be disposed to face each other with the brake disk 20 interposed therebetween. A friction pad including a material having a high friction coefficient, such as rubber, may be attached to one surface of the brake pad 30 that faces the brake disk 20.

The plate part 203 may extend downward from one side of the bridge part 202. The plate part 203 may be disposed to face any one of the pair of brake pads 30.

When the bridge part 202 is moved toward a direction in which the main body part 201 is placed, the plate part 203 may pressurize the brake pad 30 spaced apart from the brake disk 20 toward the brake disk.

The opened side of the first cylinder 100a according to the present embodiment may be disposed to face any one of the pair of brake pads 30.

The opened side of the first cylinder 100a may be disposed to face the brake pad 30 that is spaced apart from the brake disk 20, among the pair of brake pads 30, in the direction opposite to the first direction. The opened side of the first cylinder 100a may be spaced apart from the brake pad 30 that is spaced apart from the brake disk 20 in the direction opposite to the first direction at a set interval.

A central axis C2 of the first cylinder 100a that is parallel to the first direction may be disposed in parallel to a central axis C1 of the brake disk 20 that is parallel to the first direction. The central axis C2 of the first cylinder 100a may be spaced apart from the central axis C1 of the brake disk 20 in the second direction.

The second direction may be exemplified as a direction that is perpendicular to the first direction and directed from the central axis C1 of the brake disk 20 toward the central axis C2 of the first cylinder. The second direction may be a direction that rises in a direction that is perpendicular to the ground, that is, the Z axis direction on the basis of FIG. 19, when the bottom of the bridge part 202 is disposed to be parallel to the ground.

The brake apparatus for a vehicle according to the present embodiment may include a first nut screw 410, a first bolt screw 420, and a first piston 430.

The first nut screw 410 is rotatably disposed in the first cylinder 100a, and may be connected to the first bolt screw 420. A first bearing 440 that rotatably supports the first nut screw 410 may be installed within the first cylinder 100a.

The first bearing 440 may be combined with the first nut screw 410. The first bearing 440 may be press-fitted within the first cylinder 100a. The first bearing 440 may be exemplified as a ball bearing that is provided between the first cylinder 100a and the first nut screw 410.

The first nut screw 410 may be formed in a hollow shape in which the first nut screw 410 has the inside emptied and both ends opened. The first nut screw 410 may be disposed within the first cylinder 100a. The central axis of the first nut screw 410 that is parallel to the first direction may be placed on the same axis line as the central axis C2 of the first cylinder 100a.

One side (i.e., the left side on the basis of FIG. 19) of the first nut screw 410 may be disposed to face the inner surface of the first piston 430 by being spaced apart from the inner surface of the first piston 430 at a set interval. The other side (i.e., the right side on the basis of FIG. 19) of the first nut screw 410 may protrude to the outside of the first cylinder 100a through a closed side of the first cylinder 100a.

The other side of the first nut screw 410 may be connected to a driving part (not illustrated). The driving part is combined with the cylinder part 100, and may generate a driving force so that the first piston 430 can reciprocate.

When the driving part operates, the first nut screw 410 may be rotated in a clockwise direction or a counterclockwise direction around the central axis that is parallel to the first direction.

The inner surface of the first nut screw 410 may be disposed to face the outer surface of the first bolt screw 420. A ball rail on which the circumference of a ball member 41 having a spherical shape on one side thereof is seated may be formed in the inner circumferential surface of the first nut screw 410. Such a ball rail may extend in a spiral form in the length direction of the first nut screw 410, that is, in the direction parallel to the first direction, and may provide the circulation path of the ball member 41.

The first bolt screw 420 may be moved within the first cylinder 100a in the first direction or the direction opposite to the first direction while operating in conjunction with the rotation of the first nut screw 410. The first bolt screw 420 may be disposed within the first nut screw 410. The first bolt screw 420 may be disposed to penetrate both ends of the first nut screw 410.

The first bolt screw 420 may pressurize the first piston 430 in the first direction as the first bolt screw 420 is moved in the first direction, and may release pressurization for the first piston 430 as the first bolt screw 420 is moved in the direction opposite to the first direction.

The first bolt screw 420 according to the present embodiment may include a first bolt body part 421 and a first bolt head part 422.

The first bolt body part 421 may be formed in a bar or pole shape in which the first bolt body part 421 has an approximately circular cross section. The first bolt body part 421 is disposed within the first cylinder 100a. A central axis of the first bolt body part 421 that is parallel to the first direction may be placed on the same axis line as the central axis C2 of the first cylinder 100a. The first bolt body part 421 may be combined with the first nut screw 410 through the medium of the ball member 41.

A ball rail on which the circumference of the ball member 41 on the other side thereof is seated may be formed in the outer circumferential surface of the first bolt body part 421. Such a ball rail may extend in a spiral form in the length direction of the first bolt body part 421, that is, in the direction parallel to the first direction, and may provide the circulation path of the ball member 41. Accordingly, when the first nut screw 410 is rotated, the first bolt body part 421 may be moved in the first direction or the direction opposite to the first direction by a circulation movement of the ball member 41.

The first bolt head part 422 may be disposed between the first bolt body part 421 and the first piston 430. The first bolt head part 422 may be formed to have an approximately circular cross section. The first bolt head part 422 may be inserted into the first piston 430. The first bolt head part 422 may be disposed to face the inner surface of the first piston 430 by being spaced apart from the inner surface of the first piston 430 at a set interval.

The first bolt head part 422 may pressurize the first piston 430. The first bolt head part 422 may pressurize the first piston 430 or release pressurization for the first piston 430 in the first direction according to the moving direction of the first bolt body part 421.

The first bolt head part 422 may be provided on one side (i.e., the left side on the basis of FIG. 19) of the first bolt body part 421 that is disposed to face the first piston 430.

The diameter of the first bolt head part 422 may be formed to be greater than the diameter of the first bolt body part 421. The outside diameter of the first bolt head part 422 may be formed to be greater than the inside diameter of the first nut screw 410. Accordingly, the first bolt head part 422 may protrude from the first nut screw 410.

As the first bolt body part 421 is moved in the first direction, the first bolt head part 422 may come into contact with the inner surface of the first piston 430 and pressurize the first piston 430 in the first direction.

As the first bolt body part 421 is moved in the direction opposite to the first direction, the first bolt head part 422 may be separated from the inner surface of the first piston 430, and may release a pressing force that is applied to the first piston 430.

The first bolt head part 422 according to the present embodiment may further include a first pressurization part 422a that comes into contact with the inner surface of the first piston 430.

The first pressurization part 422a may be formed in the first bolt head part 422 in a way to protrude therefrom. The first pressurization part 422a protrudes from the outer circumferential surface of the first bolt head part 422, and may be formed in the circumferential direction of the first bolt head part 422.

The first pressurization part 422a may be provided on one side (i.e., the left side on the basis of FIG. 19) of the first bolt head part 422 toward a direction in which the first piston 430 is placed.

The first piston 430 may be installed in the first cylinder 100a in a way to be movable in the first direction or the direction opposite to the first direction. The first piston 430 may be disposed within the first cylinder 100a. The first piston 430 may be formed in a hollow shape in which one side of the first piston 430 is opened. A closed side of the first piston 430 may be disposed toward the brake pad 30 that is disposed to face the first cylinder 100a.

The opened side of the first piston 430 may be disposed toward the internal space of the first cylinder 100a. The outer surface of the first piston 430 may be slidably supported by the inner surface of the first cylinder 100a. In contrast, the outer surface of the first piston 430 may form a gap by being spaced apart from the inner surface of the first cylinder 100a at a set distance. The first bolt head part 422 may be inserted into the first piston 430.

As the first piston 430 is moved in the first direction, the first piston 430 may protrude to the outside of the first cylinder 100a, and may pressurize the brake pad 30 that is disposed to face the first cylinder 100a toward the brake disk 20.

A first piston boot 450 that prevents the introduction of an external alien substance and that water-tightly seals the inside of the first cylinder 100a may be installed within the first cylinder 100a according to the present embodiment. The first piston boot 450 may be installed between the first cylinder 100a and the first piston 430. The first piston boot 450 is combined with the first piston 430, and may be press-fitted within the first cylinder 100a.

The first piston boot 450 may be formed to surround the first piston 430. The first piston boot 450 may include an elastically deformable material. For example, the first piston boot 450 may be fabricated to include a rubber material. The first piston boot 450 may be formed to have a ruffled shape.

The brake apparatus for a vehicle according to the present embodiment may include a second nut screw 510, a second bolt screw 520, and a second piston 530.

The second nut screw 510 is rotatably disposed in the second cylinder 100b, and may be connected to the second bolt screw 520. The second nut screw 510 may be disposed to be spaced apart from the first nut screw 410 in the third direction.

A second bearing 540 that rotatably supports the second nut screw 510 may be installed within the second cylinder 100b. The second bearing 540 may be combined with the second nut screw 510. The second bearing 540 may be press-fitted within the second cylinder 100b.

The second bearing 540 may be exemplified as a ball bearing that is provided between the second cylinder 100b and the second nut screw 510.

The second nut screw 510 may be formed in a hollow shape in which the second nut screw 510 has the inside emptied and both ends opened. The second nut screw 510 is disposed within the second cylinder 100b. A central axis of the second nut screw 510 that is parallel to the first direction may be placed on the same axis line as a central axis C3 of the first cylinder 100b.

One side (i.e., the right side on the basis of FIG. 21) of the second nut screw 510 may be disposed to face the inner surface of the second piston 530 by being spaced apart from the inner surface of the second piston 530 at a set interval. The other side (i.e., the left side on the basis of FIG. 21) of the second nut screw 510 may protrude to the outside of the second cylinder 100b through a closed side of the second cylinder 100b.

The other side of the second nut screw 510 may be connected to a driving part. The driving part may generate a driving force so that the second piston 530 can reciprocate. The driving part may generate a driving force so that both the first piston 430 and the second piston 530 can reciprocate.

When the driving part operates, the second nut screw 510 may be rotated the clockwise direction or the counterclockwise direction around the central axis that is parallel to the first direction. When the driving part operates, both the first nut screw 410 and the second nut screw 510 may be rotated in the clockwise direction or the counterclockwise direction around the central axis that is parallel to the first direction.

The inner surface of the second nut screw 510 may be disposed to face the outer surface of the second bolt screw 520. A ball rail on which the circumference of a ball member 51 having a spherical shape on one side thereof is seated on may be formed in the inner circumferential surface of the second nut screw 510. Such a ball rail may extend in a spiral form in the length direction of the second nut screw 510, that is, in the direction parallel to the first direction, and may provide the circulation path of the ball member 51.

The second bolt screw 520 may be moved within the second cylinder 100b in the first direction or the direction opposite to the first direction while operating in conjunction with the rotation of the second nut screw 510. Both the first bolt screw 420 and the second bolt screw 520 may be moved in the first direction or the direction opposite to the first direction while operating in conjunction with the rotation of the first nut screw 410 and the second nut screw 510, respectively.

The second bolt screw 520 may be disposed within the second nut screw 510. The second bolt screw 520 may be disposed to penetrate both ends of the second nut screw 510.

The second bolt screw 520 may pressurize the second piston 530 in the first direction as the second bolt screw 520 is moved in the first direction, and may release pressurization for the second piston 530 as the second bolt screw 520 is moved in the direction opposite to the first direction.

The second bolt screw 520 according to the present embodiment may include a second bolt body part 521 and a second bolt head part 522.

The second bolt body part 521 may be formed in a bar or pole shape in which the second bolt body part 521 has an approximately circular cross section. The second bolt body part 521 is disposed within the second cylinder 100b. A central axis of the second bolt body part 521 that is parallel to the first direction may be placed on the same axis line as the central axis C3 of the second cylinder 100b. The second bolt body part 521 may be combined with the second nut screw 510 through the medium of the ball member 51.

A ball rail on which the circumference of the ball member 51 on the other side thereof is seated on may be formed in the outer circumferential surface of the second bolt body part 521. Such a ball rail may extend in the length direction of the second bolt body part 521, that is, in the direction parallel to the first direction in a spiral form, and may provide the circulation path of the ball member 51. Accordingly, when the second nut screw 510 is rotated, the second bolt body part 521 may be moved in the first direction or the direction opposite to the first direction by a circulation movement of the ball member 51.

The second bolt head part 522 may be disposed between the second bolt body part 521 and the second piston 530. The second bolt head part 522 may be formed to have an approximately circular cross section. The second bolt head part 522 may be inserted into the second piston 530. The second bolt head part 522 may be disposed to face the inner surface of the second piston 530 by being spaced apart from the inner surface of the second piston 530 at a set interval.

The second bolt head part 522 may pressurize the second piston 530. The second bolt head part 522 may pressurize the second piston 530 or release pressurization for the second piston 530 in the first direction according to the moving direction of the second bolt body part 521.

The second bolt head part 522 may be provided on one side (i.e., the right side on the basis of FIG. 21) of the second bolt body part 521 that is disposed to face the second piston 530.

The diameter of the second bolt head part 522 may be formed to be greater than the diameter of the second bolt body part 521. The outside diameter of the second bolt head part 522 may be formed to be greater than the inside diameter of the second nut screw 510. Accordingly, the second bolt head part 522 may protrude from the second nut screw 510.

As the second bolt body part 521 is moved in the first direction, the second bolt head part 522 may come into contact with the inner surface of the second piston 530 and pressurize the second piston 530 in the first direction.

As the second bolt body part 521 is moved in the direction opposite to the first direction, the second bolt head part 522 may be separated from the inner surface of the second piston 530 and release a pressing force that is applied to the second piston 530.

The second bolt head part 522 according to the present embodiment may further include a second pressurization part 522a that comes into contact with the inner surface of the second piston 530.

The second pressurization part 522a may be formed to protrude from the second bolt head part 522. The second pressurization part 522a protrudes from the outer circumferential surface of the second bolt head part 522, and may be formed in the circumferential direction of the second bolt head part 522.

The second pressurization part 522a may be provided on one side (i.e., the right side on the basis of FIG. 21) of the second bolt head part 522 toward a direction in which the second piston 530 is placed.

The second piston 530 may be installed in the second cylinder 100b in a way to be movable in the first direction or the direction opposite to the first direction. The second piston 530 may be disposed within the second cylinder 100b. The second piston 530 may be formed in a hollow shape in which one side of the second piston 530 is opened. A closed side of the second piston 530 may be disposed toward the brake pad 30 that is disposed to face the second cylinder 100b.

The opened side of the second piston 530 may be disposed toward an internal space of the second cylinder 100b. The outer surface of the second piston 530 may be slidably supported by the inner surface of the second cylinder 100b. In contrast, the outer surface of the second piston 530 may form a gap by being spaced apart from the inner surface of the second cylinder 100b at a set distance. The second bolt head part 522 may be inserted into the second piston 530.

As the second piston 530 is moved in the first direction, the second piston 530 may protrude to the outside of the second cylinder 100b and pressurize the brake pad 30 that is disposed to face the second cylinder 100b toward the brake disk 20.

A second piston boot 550 that prevents the introduction of an external alien substance and that water-tightly seals the inside of the second cylinder 100b may be installed within the second cylinder 100b according to the present embodiment. The second piston boot 550 may be installed between the second cylinder 100b and the second piston 530. The second piston boot 550 is combined with the second piston 530, and may be press-fitted within the second cylinder 100b.

The second piston boot 550 may be formed to surround the second piston 530. The second piston boot 550 may include a rubber material which is elastically deformable. The second piston boot 550 may be formed to have a ruffled shape.

The fastening member 300 may fasten the cylinder part 100 to the caliper body 200. The direction in which the fastening member 300 according to the present embodiment is fastened may be directed toward the direction parallel to the second direction. The fastening member 300 may fasten the cylinder part 100 and the caliper body 200 in the direction parallel to the second direction.

In an embodiment, the fastening member 300 may be fastened to the caliper body 200 through the flange part 120. In another embodiment, the fastening member 300 may be fastened to the flange part 120 through the caliper body 200.

The fastening member 300 according to the present embodiment may be exemplified as a bolt, including a body part in which a screw thread is formed in the outer circumferential surface of the body part and a head part that is provided on one side of the body part and that has a greater diameter than the body part.

A part of the fastening member 300 may pass through the through-hole 120a. The diameter of the through-hole 120a may be formed to be greater than the body part of the fastening member 300, and may be formed to be smaller than the head part of the fastening member 300. Accordingly, only the body part of the fastening member 300 may pass through the through-hole 120a.

The fastening member 300 according to the present embodiment may include a first fastening member 310, a second fastening member 320, and a third fastening member 330.

The first fastening member 310 and the second fastening member 320 may be disposed to be spaced apart from each other in the direction parallel to the first direction.

The first fastening member 310 may be combined with the caliper body 200 by penetrating the flange part 120 in the second direction. The first fastening member 310 may be combined with the caliper body 200 by penetrating the first flange part 121 and the second flange part 122 in the second direction.

A body part of the first fastening member 310 may be threadedly engaged with the caliper body 200 through the through-hole 120a formed in the flange part 120.

In another embodiment, the first fastening member 310 may be combined with the flange part 120 by penetrating the caliper body 200 in a direction opposite to the second direction.

The second fastening member 320 may be disposed to be spaced apart from the first fastening member 310 in the direction opposite to the first direction. The second fastening member 320 may be combined with the caliper body 200 by penetrating the flange part 120 in the second direction. The second fastening member 320 may be combined with the caliper body 200 by penetrating the first flange part 121 and the second flange part 122 in the second direction.

A body part of the second fastening member 320 may be threadedly engaged with the caliper body 200 through the through-hole 120a formed in the flange part 120.

In another embodiment, the second fastening member 320 may be combined with the flange part 120 by penetrating the caliper body 200 in the direction opposite to the second direction.

The diameter of the first fastening member 310 and the diameter of the second fastening member 320 according to the present embodiment may be formed to be different. For example, the diameter of the first fastening member 310 may be formed to be greater than the diameter of the second fastening member 320. Incidentally, the diameter of the body part of the first fastening member 310 that passes through the through-hole 120a may be formed to be greater than the diameter of the body part of the second fastening member 320.

As the diameter of the first fastening member 310 is formed to be greater than the diameter of the second fastening member 320, a deformation of the caliper body 200 can be prevented because a shearing load that is generated in the axial direction of the cylinder part 100, that is, in the direction parallel to the first direction, and a vertical load that is generated in a direction orthogonal to the axial direction of the cylinder part 100, that is, in the direction parallel to the second direction, when the braking force of the caliper body 200 is generated can be supported.

A deformation, such as the widening of a gap between the main body part 201 and the plate part 203 on the basis of the bridge part 202 because the shearing load and the vertical load are applied to the caliper body 200 when the braking force of the caliper body 200 is generated, can be prevented.

The third fastening member 330 may be combined with the cylinder part 100. The third fastening member 330 may be threadedly engaged with the tapped portion 130 provided in the cylinder body 110 by penetrating the caliper body 200 in the direction opposite to the second direction. The direction in which the third fastening member 330 is fastened and the direction in which the first fastening member 310 and the second fastening member 320 are fastened may be opposite directions.

The third fastening member 330 may be provided in plurality. The plurality of third fastening members 330 may be disposed to be spaced apart from each other in the direction parallel to the first direction.

The third fastening member 330 can prevent a deformation of the caliper body 200 because the third fastening member 330 can support a shearing load that is generated in the axial direction of the cylinder part 100, that is, in the direction parallel to the first direction, and a vertical load that is generated in a direction orthogonal to the axial direction of the cylinder part 100, that is, in the direction parallel to the second direction, when the braking force of the caliper body 200 is generated.

A deformation, such as the widening of a gap between the main body part 201 and the plate part 203 on the basis of the bridge part 202 because the shearing load and the vertical load are applied to the caliper body 200 when the braking force of the caliper body 200 is generated, can be prevented.

The brake apparatus for a vehicle according to an embodiment of the present disclosure can secure the stiffness of the caliper body 200 by minimizing a load that is applied to the fastening member 300 because the plurality of fastening members 300 that fastens the cylinder part 100 and the caliper body 200 supports a shearing load when the braking force of the caliper body 200 is generated.

The brake apparatus for a vehicle according to an embodiment of the present disclosure can achieve a reduction in the size of the cylinder part 100, quality stabilization through the publicization of all KIT specifications, a reduction of investment costs, and the reinforcement of competitiveness attributable to the maximization of output because the cylinder part 100 including the ball screw 430 and the piston 530 is composed of a compact modularization KIT and assembled with the caliper body 200.

The brake apparatus for a vehicle according to an embodiment of the present disclosure can minimize the length in the axial direction thereof by applying the nut-driven type in which a rotational motion of the nut is changed into a linear motion of the screw.

The brake apparatus for a vehicle according to an embodiment of the present disclosure can reduce weight through material dualization and a reduction of the size.

The brake apparatus for a vehicle according to an embodiment of the present disclosure can improve profitability through a productivity increase and the improvement of production efficiency through the improvement of a process and assembly.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

1. A brake apparatus for a vehicle, the apparatus comprising:
a cylinder;
a nut screw rotatably disposed in the cylinder;
a bolt screw being movable in a first direction or a direction opposite to the first direction while operating in conjunction with the rotation of the nut screw;
a piston movably disposed in the cylinder and moved in the first direction by a pressurization of the bolt screw;
a caliper body surrounding a part of the cylinder; and
a fastening member fastening the cylinder to the caliper body.

2. The brake apparatus of claim 1, wherein a direction in which the fastening member is fastened is directed toward a direction parallel to a second direction that intersects the first direction.

3. The brake apparatus of claim 2, wherein the cylinder comprises:
a cylinder body part; and
a flange part protruding along a third direction that intersects the first direction and the second direction from an outer circumferential surface of the cylinder body part and comprising a through-hole through which a part of the fastening member passes.

4. The brake apparatus of claim 3, wherein a plurality of flange parts is disposed to be spaced apart from each other along a circumferential direction of the cylinder body part.

5. The brake apparatus of claim 3, wherein the caliper body comprises a tapped portion that comes into contact with the flange part and in which a tapped hole with which the fastening member that passes through the through-hole is combined is formed.

6. The brake apparatus of claim 5, wherein the fastening member comprises:
a first fastening member; and
a second fastening member disposed to be spaced apart from the first fastening member in the direction opposite to the first direction.

7. The brake apparatus of claim 6, wherein a diameter of the first fastening member and a diameter of the second fastening member are different.

8. The brake apparatus of claim 7, wherein the diameter of the first fastening member is greater than the diameter of the second fastening member.

9. The brake apparatus of claim 6, wherein the flange part comprises:
a first flange part through which the first fastening member passes; and
a second flange part that extends in the direction opposite to the first direction from the first flange part and through which the second fastening member passes.

10. The brake apparatus of claim 9, wherein a height of the first flange part and a height of the second flange part that are parallel to the second direction are different.

11. The brake apparatus of claim 10, wherein the height of the second flange part is lower than the height of the first flange part.

12. The brake apparatus of claim 9, wherein the tapped portion comprises:
a first tapped portion configured to come into contact with the first flange part; and
a second tapped portion extending in the direction opposite to the first direction from the first tapped portion and configured to come into contact with the second flange part.

13. The brake apparatus of claim 12, wherein a height of the first tapped portion and a height of the second tapped portion that are parallel to the second direction are different.

14. The brake apparatus of claim 13, wherein the height of the first tapped portion is lower than the height of the second tapped portion.

15. A brake apparatus for a vehicle, the brake apparatus comprising:
a cylinder part comprising a first cylinder and a second cylinder;
a caliper body surrounding a part of the cylinder part; and
a fastening member fastening the cylinder part to the caliper body.

16. The brake apparatus of claim 15, further comprising:
a first nut screw rotatably disposed in the first cylinder;
a first bolt screw being movable in a first direction or a direction opposite to the first direction while operating in conjunction with the rotation of the first nut screw; and
a first piston movably disposed in the first cylinder and moved in the first direction by a pressurization of the first bolt screw.

17. The brake apparatus of claim 16, further comprising:
a second nut screw rotatably disposed in the second cylinder;
a second bolt screw being movable in the first direction or the direction opposite to the first direction while operating in conjunction with the rotation of the second nut screw; and
a second piston movably disposed in the second cylinder and moved in the first direction by a pressurization of the second bolt screw.

18. The brake apparatus of claim 17, wherein a direction in which the fastening member is fastened is directed toward a direction parallel to a second direction that intersects the first direction.

19. The brake apparatus of claim 18, wherein the fastening member comprises:
a first fastening member; and
a second fastening member disposed to be spaced apart from the first fastening member in a direction parallel to the first direction.

20. The brake apparatus of claim 19, wherein a diameter of the first fastening member and a diameter of the second fastening member are different.
